(19) United States
(12) Patent Application Publication
(10) Pub. No.: US 2005/0154588 A1
(43) Pub. Date: Jul. 14, 2005

(54) Speech recognition and control in a process support system

(76) Inventors: John J. Janas III, Concord, NH (US); Sandra Ignacio, Foster City, CA (US); Beverly Blackman, Sunnyvale, CA (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/031,937

(22) Filed: Jan. 7, 2005

Related U.S. Application Data
(63) Continuation-in-part of application No. 10/017,652, filed on Dec. 12, 2001.

(51) Int. Cl. G10L 15/00

(52) U.S. Cl. 704/249

(57) ABSTRACT

A voice navigation, command and data entry input system for a decision support and electronic record system including a phoneme identification mechanism for identifying phonemes in a voice input signal and generating phoneme identifiers and a word identification mechanism for identifying and providing words corresponding to the phoneme identifications to the decision support and electronic record system. The system includes individual user phoneme identification libraries and field of use, command/navigation and common vocabulary word libraries. A voice input device generates a voice input signal and includes a plurality of voice input device keys for generating control/navigation input control signals.

### CROSS REFERENCES TO RELATED APPLICATIONS

The present patent application is related to and is a continuation in part application from U.S. patent application Ser. No. 10/017,652 filed 12 Dec. 2001 by John J. Janas III, et al. for a MEDICAL SUPPORT SYSTEM, and claims benefit of U.S. patent application Ser. No. 10/017,652.

### FIELD OF THE INVENTION

The present invention is related to a method and system for speech recognition and control in a service provider support system involving complex interplay of factors including absorbing data, recommendations and guidelines and requirements from a range of sources and meeting stringent requirements to fully record the processes.

### BACKGROUND OF THE INVENTION

Many professions require that practitioners and para-practitioners make judgments and decisions based upon or influenced by a complex interplay of data, information, factors and requirements from a range of sources, including stringent requirements to fully record the judgements and decisions and the judgement and decision making processes. A typical example is the medical profession, wherein a doctor or paramedical, such as a nurse practitioner, is required to acquire and consider a large volume of current and historical patient information. The practitioner is then required to evaluate the patients present and probable future conditions and trends or developments, to decide whether and what treatments or changes in treatments are necessary or preferred, and whether to acquire further information and what procedures or methods to use in acquiring the additional information. These processes are further complicated in that the practitioner is presented with a continuous flow or even flood of new and continuously changing information, recommendations and requirements and with ever expanding and changing requirements to thoroughly record the processes executed by the practitioner, including the decisions and proposed actions and the data and information from which the decisions were made.

For example, the medical services industry, including medical researchers, pharmaceutical companies, medical equipment companies, hospitals and other medical treatment related enterprises are engaged in the continuous development of new medications and methods for treatment of diseases or medical conditions, and recommendations for the use of the new medications or methods. Yet other organizations, such as the medical insurance organizations of various types, issue medical treatment guidelines based upon the guidelines developed by the professional organizations and medical industry and upon their own requirements and goals. These goals and requirements not only change continuously, but may conflict with the guidelines and recommendations of, for example, the professional organizations or those of other insurance organizations. As a consequence, practitioners are often overwhelmed with a flood of information regarding each specific patient, the current and changing tests, guidelines, recommendations, medications and treatments for various diseases or conditions, conflict among the requirements or recommendations of various professional or service organizations, and various reporting requirements or requests.

The practitioner is thereby faced with increasingly complex decision making processes, involving increasing volumes and types of information and sources of information, increasing and continuously changing guidelines and requirements, increasing numbers of medications and methods for treatment, increasingly numerous and more complex decision points in the processes for providing care to a patient. In addition, and due in part to the rapidly increasing flood of information and requirements flowing to the practitioner, the practitioner is confronted with a continuously increasing burden to record every step, decision, plan, proposal or thought of each process performed by the practitioner, all according to a wide range of often conflicting reporting and recording requirements.

Various practitioner support systems of the prior art, such as record generation/retrieval systems and information retrieval systems, have attempted to address these problems. Such systems of the prior art have generally been of only limited success, however, because they either do not address or only partially address the actual needs and methods of practice of the practitioners.

For example, electronic record (ER) systems such as electronic medical record (EMR) systems are in common use to generate and retrieve on-line medical records for individual patients. Such ER/EMR systems, however, do not assist the practitioner in performing medical examination and treatment processes, often referred to as “patient encounters”, but typically assist only by providing fast storage and retrieval of historical information pertaining to a patient. Because of the range and variety of medical information that could possibly be stored for a given patient, however, it is very difficult to create and maintain an electronic medical record having all of the necessary data storage fields for each patient and it is very difficult and time consuming to enter the medical data, such as test results and medications prescribed. In some systems of the prior art, for example, the system attempts to circumvent the additional burden placed on the practitioner by the record generating functions themselves by, for example, using a transcription system wherein the practitioner voice records all notes, comments and orders and those voice records are transcribed into the records or into orders and so forth by another person. Such systems, however, shift rather than decrease the workload and introduce yet another opportunities for error and misunderstanding, thereby further increasing the workload in using ER/EMR systems.

As a result, ER/EMR systems are often not used to their full potential. For example, many users attempt to implement paper record work flows in an ER/EMR system, but thereby fail to capture the true power of the ER/EMR system, such as the digital storage of data which can be imported, exported, extracted and integrated to improve work flow and quality of care.

In a like manner, there are many on-line information retrieval systems available to the practitioner and through which a practitioner may search for and retrieve information pertaining to diagnostic symptoms, guidelines for treatment, medications and medication effects, insurance policies and requirements, and so on. While such information retrieval systems provide wide access to a vastly increased range of information, such systems are essentially merely substitutes for traditional hard copy references. Again, such systems are typically slow and cumbersome and too difficult, complex and clumsy to use to be of assistance to the practitioner in real time patient encounters. As a consequence, many if not most practitioners tend to rely upon their experience and memory for such information during patient encounters or to refer to a hard copy of a reference work.

As a result, and despite experience, thorough professional training and all due care on the part of the practitioner, it is possible for a practitioner to miss or forget a factor, a test, a possible medication or a requirement or a guideline simply because of the number of factors to consider for a given patient and the current range and complexity of possible medical procedures, treatments and medications. In addition, and as is commonly known and frequently discussed, the record generation and keeping and retrieval burdens placed on various practitioners, and in particular on medical practitioners, has reached the point where record generation and keeping consumes a major part of the practitioner's time and energy, but still yields unsatisfactory results.

There have been many attempts to construct “decision support” systems and ER/EMR systems to address and alleviate these problems. The intent of such decision support systems and ER/EMR systems is to rapidly and easily provide pertinent information to the practitioner from a variety of electronically linked sources systems and to allow the practitioner to rapidly and easily create and access paperless records and to thereby enhance workflow and productivity and to decrease costs. Although experience with decision support systems and ER/EMR has shown easier access to recorded information, the overall results have been disappointing, with no improvement and often a deterioration in workflow, productivity and costs and often an increase in the workload of the practitioners using such systems.

Experience with the problems in process/service decision support systems and ER/EMR systems of the prior art have revealed two major, basic problem areas. The first problem area concerns the process/service support functions, that is, the providing of information to the practitioner for use in making decisions. In particular, the process/service support systems of the prior art essentially only replace previous information retrieval methods, that is, from paper records and references, with their electronic equivalents. This approach, however, does not provide useful and effective control and integration of the flow of relevant information to the practitioner, and a corresponding flow and integration of information from the practitioner into the process and out to where the practitioner's input is consumed, that is, in record generation, integration and distribution.

The second basic problem area lies in the interaction between the practitioner and system and, in particular, in the entry of the data and commands necessary to accomplish the desired service by the practitioner. That is, conventional input means such as keyboards, tablets, touch screens, mouses and so forth are flexible and capable of performing literally any necessary data or command input function. Such input devices, however, require specific training, practice and continuous use to become and remain proficient, and often do not accord with the natural or required working methods or practices of many practitioners or the processes performed by the practitioners. Such input devices also impose other undesirable inherent constraints. For example, the commonly used input device and graphical user interfaces typically allow input information or commands only in certain previously selected and defined formats that may not have an effective relationship with the actual needs of the practitioner or the process. Such devices and interfaces typically restricting the practitioner to predefined notes or messages, constrained spaces for note entry, limited choices on what information or commands to enter and how to enter the information or commands, and so on.

One frequently proposed approach to the above discussed problems of decision support and ER/EMR systems has been the use of voice input and control systems constructed around voice recognition engines to enter function and navigation commands and data, information and notes to be recorded, such as comments regarding a patient and the associated diagnosis and treatment plan. Voice recognition based systems, however, such as Scansoft Dragon or IBM Via Voice, do not provide the speed, accuracy and flexibility required, for example, by medical support systems, and typically require extensive training periods for both the user in how to use the system and the system in recognizing the user's voice patterns and vocabulary.

In this regard, it must be noted that these problems are essentially inherent in voice recognition systems due to the fundamental nature and the typical methods of operation of such systems. That is, voice recognition systems typically first attempt to recognize and accurately identify the various phonemes comprising human speech as spoken by a specific user, and then attempt to recognize the combinations of identified phonemes as words. There are usually some 42 commonly recognized phonemes, and obviously a very wide range of pronunciations of each phoneme due to various accents, languages and so on, and a potentially immense vocabulary of combinations of phonemes, or words. It is apparent, therefore, that such systems may be inherently slow, may have many errors, and may require extensive training time for both the user and the system. The user may also find the speech recognition process to be slow due to correction issues if there are a large number of recognition errors that must be corrected manually.

There have been a number of approaches addressing these problems, such as not using voice recognition systems. The approaches used in systems employing voice recognition engine, however, depend largely upon the type of system. Obviously, general purpose computer systems wherein the primary control/data input is by voice or text editor systems employing voice recognition engines as the primary text input path are required to preserve the maximum range of capabilities the voice recognition engine. As such, the voice recognition engines must operate with the full range of phonemes, accents, dialects and so on and as large a vocabulary of words as possible and the systems must simply tolerate the above described problems.

In systems having more defined or limited functions, however, the usual approach has been to follow essentially the same path of graphical user interfaces. That is, in systems having limited or well defined functions and purposes, the usual approach has been to limit the demands on the voice recognition engine, thereby allowing the voice recognition engine to achieve greater speed and accuracy. Unfortunately for the user, however, the usual method for reducing the load on the voice recognition engine has been to constrain the user, in so far as possible, to words comprised of the phonemes most easily, rapidly and accurately identified by the voice recognition system. Unfortunately, this approach also severely limits the vocabulary of words usable by the user, and often thereby forces the user to learn and employ a constrained and often unnatural vocabulary, and limits the range of possible control and data inputs to the processes controlled through the voice recognition system.

Stated another way, such approaches to implementing voice recognition systems forces the user and thus the processes and operations performed by the user to adapt and conform to the needs of the voice recognition engine rather than constructing the voice recognition engine and system according to the needs of the user and the user's processes and functions. These methods, however, result in systems requiring specific and extensive training, practice and continuous use to become and remain proficient and often do not accord with the natural or required working methods or practices of many practitioners or the processes performed by the practitioners. These methods also impose other undesirable constraints, such as limiting the range and type of inputs to a predetermined, predefined and limited range of inputs that typically will not meet the actual needs of the user of the processes and functions to be performed.

The present invention provides a solution to these and other related problems of the prior art.

### SUMMARY OF THE INVENTION

The present invention is directed to a voice navigation, command and data entry input system for a decision support and electronic record system.

The system of the present invention includes a core voice recognition engine that in turn includes a phoneme identification mechanism for identifying phonemes appearing in a voice input signal and generating corresponding phoneme identifiers and a word identification mechanism for identifying and providing words corresponding to the phoneme identifications as an output to the decision support and electronic record system.

The phoneme identification mechanism in turn includes an individual phoneme identification library associated with the phoneme identification mechanism for storing and providing phoneme identifications corresponding to phonemes characteristic of a voice input signal of a corresponding user.

The word identification mechanism further includes word libraries associated with the word identification mechanism for identifying and providing as an output words corresponding to the phoneme identifications wherein the words include at least one of a keystroke, a combination of keystrokes, a sequence of keystrokes, a word, a phrase, a character, a letter, a number, a symbol, a command and an instruction.

According to the present invention, the word libraries of the word identification system include a field of use library for storing and providing words specific to the field of use context of the decision support and electronic record system, a command/navigation library for storing and providing keystroke sequences pertaining to navigation through and control of operations of the decision support and electronic record system, and a common vocabulary library for storing and providing common words employed in operations of the decision support and electronic record system.

A voice input device generates the voice input signal and includes a plurality of voice input device keys for generating control/navigation input control signals for controlling control and navigation functions of the decision support and electronic record system. At least certain of the control/navigation input control signals from the voice input device keys are provided as control inputs to the word identification mechanism and the command/navigation library includes and provides keystroke sequences corresponding to the control/navigation input control signals and pertaining to navigation through and control of operations of the decision support and electronic record system.

According to the present invention, the core voice recognition process includes the steps of identifying phonemes appearing in a voice input signal and generating corresponding phoneme identifiers, including identifying and providing output words corresponding to the phoneme identifications as an output to the decision support and electronic record system. In the process of the present invention, the phoneme identifications correspond to phonemes characteristic of a voice input signal of a corresponding user and the output words include at least one of a keystroke, a combination of keystrokes, a sequence of keystrokes, a word, a phrase, a character, a letter, a number, a symbol, a command and an instruction. In a present embodiment, the output words are selected from words specific to the field of use context of the decision support and electronic record system, keystroke sequences pertaining to navigation through and control of operations of the decision support and electronic record system, and common words employed in operations of the decision support and electronic record system.

In this regard, and further according to the present invention, the generation of a voice input signal from a voice input device includes generating control/navigation input control signals for controlling control and navigation functions of the decision support and electronic record system from a plurality of voice input device keys. The output word identification and generation step in turn further includes the step of providing as output words keystroke sequences corresponding to the control/navigation input control signals and pertaining to navigation through and control of operations of the decision support and electronic record system.

### DESCRIPTION OF THE DRAWINGS

Other features, objects and advantages of the present invention will be understood by those of ordinary skill in the relevant arts after reading the following descriptions of a presently preferred embodiment of the present invention, and after examination of the drawings, wherein:

FIG. 1 is block diagrams of an exemplary system in which the present invention may be implemented;

FIG. 2 is a block diagram illustrating a medical support system of the present invention;

FIG. 3 is a block diagram illustrating medical support processes of the present invention;

FIGS. 4A through 4M illustrate process forms and process form fields for an exemplary medical support process;

FIG. 5 is a flow diagram illustrating the generation and maintenance of a medical support process;

FIG. 6 is a block diagram illustrating the adaptation of a decision support and electronic record system to voice control, navigation and data entry; and

FIG. 7 is a diagrammatic representation of a voice control, navigation and data entry system of the present invention.

### DETAILED DESCRIPTION OF THE INVENTION

The following will first describe a process/service decision support system and ER/EMR system of the present invention. As will be described, a decision support/electronic record system of the present invention provides useful and effective control and integration of the flow of relevant information to the practitioner, including the integration of information from electronic records, and a corresponding flow and integration of information from the practitioner into the process for record generation, integration and distribution.

The following will then describe a voice recognition engine employed as a primary system input to the above described decision support/electronic record system wherein the voice recognition input engine of the present invention addresses and overcomes the above discussed problems of such input engines.

A. Decision Support/Electronic Record System

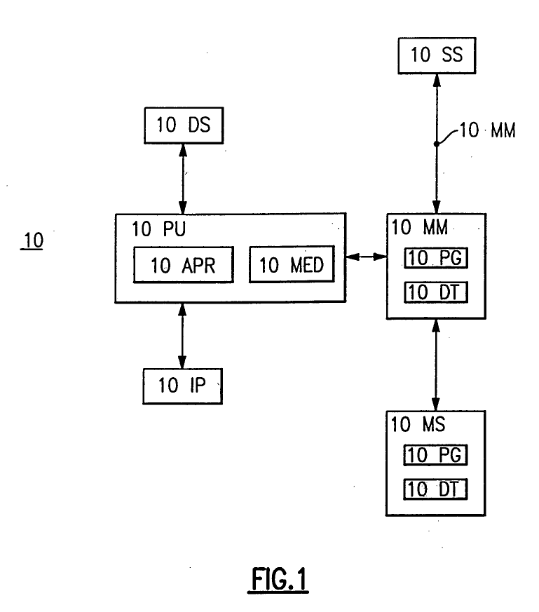

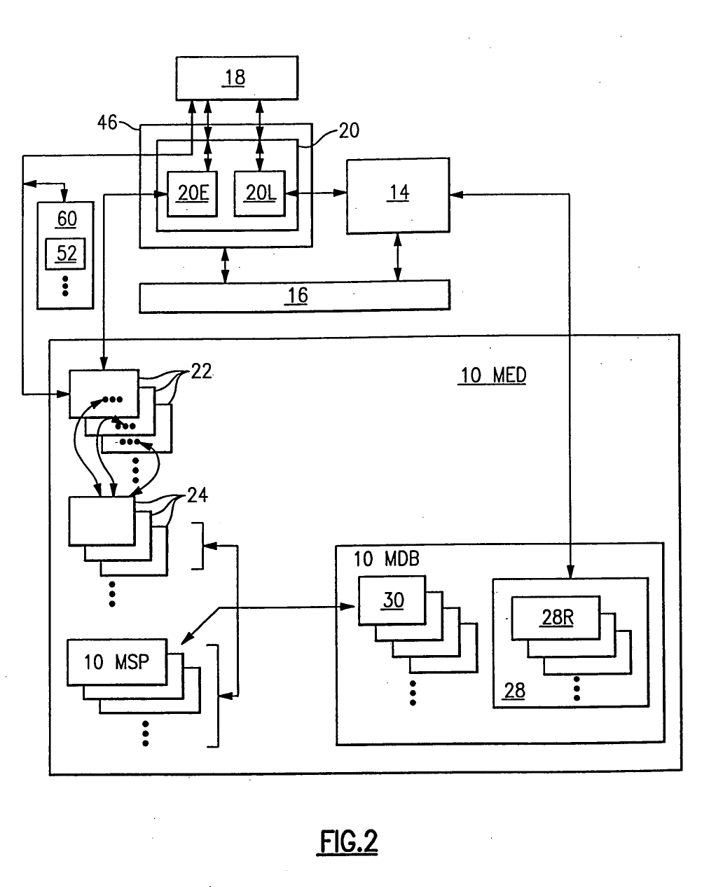

Referring to FIGS. 1 and 2, therein is shown illustrative block diagrams of a Decision Support/Electronic Record System (DS/ERS 10) of the present invention as embodied as an exemplary medical support system.

As indicated in FIG. 1, a DS/ERS 10 will typically be implemented in a general purpose Computer System 10CS that will typically include a Processor Unit 10PU, a Memory 10MM with one or more associated Mass Storage Device 10MS for storing Programs 10PG and Data 10DT, one or more Input Devices 10ID for user inputs, such as a keyboard, mouse or touch screen, and a Display 10DS for display of information to a user. A DS/ERS 10 may be implemented in, for example, a desktop, laptop or notebook computer, as terminals or computers networked with data and program Servers 10SS through local or wide area Networks 10NN, including wireless networks, or in wireless networked palmtop devices of appropriate memory, processing and display capacity.

As will be well understood by those of ordinary skill in the relevant arts, a DS/ERS 10 will perform or execute Processes 10PR controlling, performing or supporting the functions and operations of the DS/ERS 10, including, in the present example, medical support system processes. In the present exemplary medical support system, the Processes 10PR of a DS/ERS 10 will typically include, for example, Administrative Processes 10APR pertaining to the administrative and management functions of the DS/ERS 10, such as operating system functions, and Medical Processes 10MED comprising the medical support system functions of the present invention. Processes 10PR are defined and controlled by Programs 10PG and, for example, user data input provided through Input Devices 10ID and data read from databases or other data sources, may reside in one or more Mass Storage Devices 10MS.

As will be described in the following, the Medical Processes 10MED comprising the medical support system functions of the present invention is not constrained to the generation and maintenance of patient medical records, although these operations are within the scope of functions supported by the Medical Processes 10MED. Instead, a DS/ERS 10 of the present invention provides real time, interactive support for practitioners during patient encounters, such as prompts and reminders of necessary information or tests, advice and guidelines in diagnosis and treatment, decision support, therapeutic recommendations, educational information and the real time capture of metrics. The support provided by a DS/ERS 10 of the present invention is based, for example, upon the best current recommendations of, for example, professional medical organizations, studies, health care/insurance guidelines, and so on. In this regard, however, a DS/ERS 10 of the present invention does not attempt to supplant or replace the experience and judgment of the practitioner, but instead operates to maximize the workflow, mind flow and quality of practice by advisory support which may be overridden by the practitioner at any time based, for example, on the practitioner's experience or more specific knowledge regarding a particular patient.

According to the present invention, the system and method of the present invention includes or employs medical records relating to the patients and medical support databases including medical guidelines for the diagnosis and treatment of medical conditions according to current professional guidelines for the diagnosis and treatment of diseases and medical conditions and processes utilizing these databases to diagnose and recommend therapy or treatment for a patient in a manner that is supportive of but that does not interfere with the work and mind flow processes of the user. As will be described, a support process performed by a medical support system of the present invention executes an interactive dialogue between the medical support process and the user to provide guidance to the user in performing the medical support process according to the guidelines and dependent upon the user inputs and the medical record. A medical support process performed by the present invention for a given condition or disease includes one or more process phases, which may include a data entry and review phase, a diagnostic phase and a therapeutic/treatment recommendation phase, which are presented to a user through process forms providing graphic interfaces for the entry and display of information regarding the support process.

Referring to FIG. 2, it is illustrated therein that in a presently preferred and typical embodiment of a DS/ERS 10, the Medical Processes 10MED of the present invention are constructed on and use the facilities and functions of a conventional Electronic Medical Record System (EMR) 12, such as MedicaLogic/Medscape Logician® from MedicaLogic/Medscape Corporation, and a conventional Database Program 14, such as an Oracle® server relational database. As is well understood in the relevant arts, in a conventional medical record system EMRs 12 and Database Programs 14 operate on an Operating Systems 16, such as Microsoft Windows®, and with either a thick or thin Client Interface 18, to construct, manage, store and retrieve patient medical records. It will be understood, however, that MedicaLogic/Medscape Logician® and the Oracle® database are representative and exemplary of a range of readily available, conventional electronic medical record programs and databases used to construct, manage, store and retrieve patient medical records. It will also be understood that these functions of a DS/ERS 10 may be implemented through any similar or equivalent programs, or through corresponding programs generated specifically for a DS/ERS 10.

As illustrated in FIG. 2, an EMR 12 typically includes an Interface Mechanism 20 which comprises a plurality of mechanisms and functions for entering data into and reading data from the associated databases. In MedicaLogic/Medscape Logician®, for example, this mechanism is referred to as the MedicaLogic Expression Language (MEL) and comprises a software code platform that allows input to and output from the relational database. An Interface Mechanism 20 will typically include a Language 20L which comprises defined terms and syntax for defining database records, the fields and contents of the database records, formulating queries and searches of the database records, relating and parsing the fields and contents of the database records, reading data from and entering data into the database records, and so on.

Interface Mechanism 20 will typically also include an Interface Form Editor 20E for the generation and construction of graphical user interfaces and displays of, for example, processes and database records supported and executed by the EMR 12 and associated databases. Such user interfaces and displays are typically structured and displayed as Forms 22 wherein a Form 22 comprises a structured array of Fields 24 for the display and entry of data, text, graphics, prompts, messages, “pop-up windows”, and so on, to display to a user and to allow a user to interact with, for example, Medical Processes 10MED and the associated databases. For example, a user may enter data identifying a patient into certain Fields 24 of an initial Form 22 through Input Devices 10ID and Interface Mechanism 20 will read and parse the data in the Fields 24 of the Form 22, query the associated databases with the data, and read out and display information pertaining to that patient, either in the same Form 22 or in another Form 22. The user may then enter additional data into that or an associated Form 22, such as an identification of the purpose of the current patient encounter, such as a periodic review and assessment of the patient's lipid levels. Interface Mechanism 20 will then call up and display one or more Forms 22 having Fields 24 displaying relevant information, such as data from the patient's medical records or the results of new tests, and so on. The user may then, for example, review the historical data, compare the historical data to new data, or enter new data, and so on. Interface Form Editors 22, such as the Encounter Form Editor® provided in MedicaLogic/Medscape Logician®, are well known in the art and need not be discussed in further detail further herein.

As illustrated in FIG. 2, Medical Processes 10MED of the present invention include one or more Medical Support Processes 10MSP and one or more associated Medical Databases 10MDB wherein Medical Databases 10MDB include Medical Record Databases 28 and may include one or more Medical Support Databases 30. Medical Record Databases 28 may include one or more Medical Records 28R for and corresponding to each patient, depending upon types and sources of information comprising each patient's records. Medical Record Databases 28 are constructed and used in the conventional manner to store, manage and retrieve patient Medical Records 28R and are, for example, generated, stored, managed and retrieved by and through EMR 12, as discussed briefly above. Medical Support Databases 30, in turn, contain medical information used in the medical support functions described below and may be constructed or provided from a variety of sources, but typically may be accessed by EMR 12 or EMR 12 related mechanisms of the DS/ERS 10, such as Interface Mechanism 20. As will be described in the following, Medical Support Databases 30 may be implemented in a variety of forms, such as separate databases for the various types of medical support processes provided or as data integrated into the medical support processes.

Next considering the Medical Support Processes 10MSP provided and executed by a DS/ERS 10 of the present invention, it is recognized that each interaction between a medical practitioner and a patient may be regarded as comprising one or more “encounters”. An “encounter” may in turn be defined as a procedure of one or more steps that are primarily focused upon or involved with a given medical issue and the encounters may be of variable scope or complexity. For example, a general primary physical examination comprises one or more encounters of relatively wide scope, encompassing a wide range of medical information, but of relatively low complexity, such as testing or determining whether a variety of basic medical variables are within accepted ranges Other encounters may be of lesser scope but greater depth, such as an encounter focused on control of lipid levels or of an asthma treatment, or may comprise several encounters which may be independent of one another or which may overlap or be related.

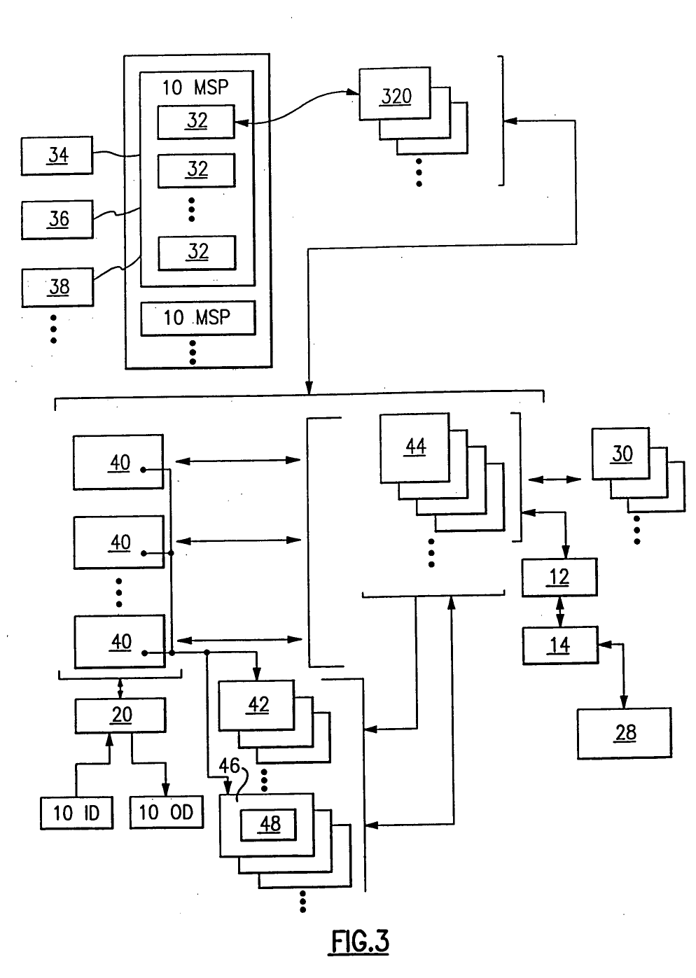

Referring to FIG. 3, in a presently preferred embodiment of a DS/ERS 10, Medical Processes 10MED include and support one or more Medical Support Processes 10MSP wherein each Medical Support Process 10MSP corresponds to a specific type of encounter. For example, one Medical Support Process 10MSP may implement a medical process for the control of lipid levels while another may implement procedures for the evaluation, diagnosis and treatment of asthma or a cardiac condition. As illustrated in FIG. 3, a Medical Support Process 10MSP comprises a plurality of Process Phases 32 wherein each Process Phase 32 is focused on a certain aspect or aspects of the Medical Support Process 10MSP and comprises one or more Process Operations 32O. For example, a typical Medical Support Process 10MSP may include two basic Process Phases 32, respectively referred to as the Data Capture (Data) Phase 34 and the Assessment/Diagnosis (Assessment) Phase 36, and may include a third basic Process Phase 32, referred to as the Recommendations Phase 38.

A Data Phase 34 is generally comprised of operations to acquire, enter and review historical and new information pertaining to the medical condition of a patient for the purposes of the current encounter, and may typically be performed by a nurse or para-practitioner. Such operations may include, for example, entry of the current date, entry of current measurements, such as blood pressure and heart rate, the entry or confirmation of entry of current or recent tests or procedures, such as blood or cholesterol screening, the entry of information from the patient, such as recent number and severity of asthma attacks, and so on, and the review of the present and historical information, including medication and other treatment plans. The procedures of Data Phase 34 will often include the generation of prompts and reminders to the user. Such prompts and reminders will typically be dependent upon the purpose of the encounter and, for example, may insure that information necessary to or desirable the procedure are acquired and entered. For example, the user may be prompted to determine and enter a current blood pressure, heart rate and weight, to ask certain relevant questions of the patient, such as the patient's perceptions of the effects of a medication, and so on.

The Assessment Phase 36 would typically be performed by a practitioner or para-practitioner and is essentially comprised of procedures to assess the patient's condition and treatment based upon the information acquired or updated in Data Phase 34 and, for example, to assist in the diagnosis of the patient's condition and treatment. For example, procedures of Assessment Phase 36 may present medical guidelines for assessment and treatment of the severity or level of a patient's condition based upon current information and may suggest tests or procedures to be performed or that should be performed at regular intervals or that are due to be performed Assessment Phase 36 may also include procedures to suggest reminders of other conditions that may arise from or be related to the patient's current condition or that may result in similar symptoms and should be considered, and so on Other information provided to the user may include suggested medications, including the effects, side effects and interaction effects of the medications, reminders of medications that have been used previously or other medications currently being used by the patient for other reasons, and so on. As described herein above, however, all such reminders, suggestions and prompts are presented to the practitioner as reminders and suggestions and the user may override such reminders, suggestions and prompts based, for example, the practitioner's experience or knowledge of the particular patient or of other factors, and will typically be provided with fields to enter the reasons for disagreement with the guidelines, which will be automatically entered in the patient's Medical Records 28R as a reminder to the practitioner at the next encounter with the patient.

A Medical Support Process 10MSP may also include a Recommendations Phase 38, which is typically primarily comprised of procedures to assist the practitioner in determining a course of treatment for the patient, based upon currently accepted guidelines and standards of practice in the field and for the condition of interest. These procedures may provide guidelines regarding possible medications and recommended medication levels, including the effects, side effects and interaction effects of the medications, reminders of medications that have been used previously or other medications currently being used by the patient for other reasons, suggestions for forms of treatment, suggestions for further tests and similar procedures, and so on. Although many of the Recommendations Phase 38 procedures may overlap procedures that may appear in the associated Assessment Phase 36, the procedures of the Recommendations Phase 38 will typically be in greater depth and at a greater level of detail than will those of the Assessment Phase 36.

It must be noted that a Recommendations Phase 38 may not be necessary for a given Medical Support Process 10MSP, or could be an extensive supplement to the Medical Support Process 10MSP, depending on the problem, condition or disease addressed by the Medical Support Process 10MSP. It must also be noted that the Process Operations 32O of a Recommendations Phase 38 will operate to thoroughly integrate the decision and recommendation support prompts and suggestions provided by the Recommendations Phase 38 with the patient specific information, including both the historical information acquired from Medical Records 28R and the current information acquired in the Data Phase 34, so that all recommendations, suggestions and prompts are specific to and tailored to that patient at that time. For example, the patient specific information evaluated includes but is not limited to patient demographics, such as age, sex, height, weight, and so on, problems particular and specific to the patient, current and previous medications, allergies, lab values, that is, the results of laboratory tests and procedures, and patient specific observations, such as whether lipid goals have been met, and so on.

It will be apparent that the number, arrangement and relationships between Process Phases 32 in a Medical Support Process 10MSP will depend upon the nature, scope and complexity of the Medical Support Process 10MSP and of the encounter. For example, in certain Medical Support Processes 10MSP the Data Phase 34 and the Assessment Phase 36 or the Assessment Phase 36 and the Recommendations Phase 38 may be integrated or combined into a single Process State 32, or certain Process Phases 32, such as a Recommendations Phase 38, may not be required in a given Medical Support Process 10MSP. It will also be apparent that a given Medical Support Process 10MSP may include additional Process Phases 32 for specific purposes, or that a given Process Phase 32 may be organized as a number of Process sub-Phases 32 for convenience, ease of use or clarity. It will also be recognized that the number, design, arrangement and relationship among the Process Forms 40 of each Process Phase 32 will be dependent upon similar factors and judgments, as well as such factors as the graphics display capabilities of the Output Devices 10OD of the DS/ERS 10 in which the Medical Support Processes 10MSP are implemented. For example, a laptop to a desktop computer with relative high graphic display capabilities may arrange and display more information in each Process Form 40, while the more limited capabilities of, for example, a palmtop device or even a cell phone type device may require that the Process Phases 32 be implemented through a greater number of simpler Process Forms 40.

In a typical implementation of a Medical Support Process 10MSP, the Process Phases 32 and Process Operations 32O of the Medical Support Processes 10MSP are implemented and executed through Process Forms 40 and associated Support Processes 44, together with the Medical Records 28R and Medical Support Databases 30 associated with the Process Operations 32O.

Process Forms 40 and Interface Mechanism 20 comprise the interface and mechanism through which a user interacts with the Process Operations 32O comprising each Process Phase 32 of a Medical Support Process 10MSP. As described, each Process Form 40 comprises a structured array of Fields 42 for the display and entry of data, text, graphics, prompts, messages, commands, “pop-up windows”, and so on. For example, a Medical Support Process 10MSP may be initially represented by an initial Process Form 40 which presents an index of the Process Phases 32 comprising the Medical Support Process 10MSP, and “clicking” on an index tab or field may call up the first of one or more Process Forms 40 comprising the selected Process Phase 32. Within a Process Form 40 of a Process Phase 32, and as discussed further below, the user will be presented with Fields 42 for interacting with one or more Process Operations 32O comprising the Process Phase 32, such as Fields 42 for entering and displaying information or prompts pertaining to one or more Process Operations 32O. Process Forms 40 may be created, for example, by the Interface Form Editor 22 of the Interface Mechanism 20 of the EMR 12, although a Process Form Editor 40E similar to an Interface Form Editor 22 may be created specifically for this purpose.

Next considering Support Processes 44, the Process Operations 32O of each Process Phase 32, are implemented by and in Support Processes 44, each of which is an interactive process or program for performing a Process Operation 32O. In this regard, and as indicated in FIG. 3, certain Fields 42 of Process Forms 40, indicated as Process Fields 46, contain Process Calls 48 wherein each Process Call 48 is a reference, designator, “call” or invocation to or of a corresponding Support Process 44. That is, and for example, an action with respect to a Process Field 46, such as the entry of data or of a decision or command, including “clicking” on the Process Field 46 to invoke a corresponding action or activity, will in turn invoke or call a corresponding Support Process 44. In another instance, a Support Process 44 may invoke another Support Process 44, the selection of may be dependent upon the nature and results of the calling Support Process 44. In another example, multiple Process Fields 46 may refer to the same Support Process 44, as when two or more Process Fields 46 of a Process Form 40 invoke a Support Process 44 that invokes the next Process Form 40 in a sequence or group of Process Forms 40. In other instances, and again for example, the value or decision entered into a Process Field 46 may determine the Support Process 44 that is called, as when the entry of a value or decision in a Process Field 46 calls a Support Process 44 that checks the value or decision entered in a Process Field 46 and the result of the check determines the path of execution through the Support Process 44, or another Support Process 44 to be invoked. In other examples, Support Processes 44 may confirm that all necessary data is present in the Fields 42 of a Process Form 40, whether the time elapsed since a periodic test or procedure was last performed has exceeded recommended limits, or whether the test or procedure was performed at all. Other Support Processes 44 may compare the values contained in Fields 42, such as current diagnostic or test conditions and medication types of levels, and may display a prompt or suggestion or diagnosis when the values indicate a potential problem or suggest a medication or change in medication, and so on. Those of ordinary skill in the relevant arts will thereby appreciate that Support Processes 44 and Process Forms 40 allow the construction of Process Operations 32O and Medical Support Process 10MSP of any desired extent or complexity.

Finally, Medical Records 28R and the Medical Support Databases 30, the Medical Records 28R involved in the performance of a Medical Support Process 10MSP will be comprised of the Medical Records 28R of the patient that is the subject of the encounter and will typically include the patient's historical Medical Records 28R, together with new data pertaining to the patient, such as reports containing the results of current or recent tests or procedures. As described herein above, the patient Medical Records 28R will typically be accessed through Interface Mechanism 20 of the EMR 12 to read data from the Medical Records 28R or to enter data into the Medical Records 28R, either as a result of user inputs through Input Devices 10ID or by operation of one or more of Support Processes 44.

Medical Support Databases 30, in turn, contain medical information used in the execution of Support Processes 44. Medical Support Databases 30 will contain, for example, ranges or values of biological measurements, such as blood pressure, lipid levels or frequency and severity of asthma attacks that represent, according to current medical guidelines, either acceptable ranges or ranges indicating a diagnosis of a condition to be treated, guidelines for medications and medication levels, guidelines for tests or other procedures, including guidelines as to the frequency of tests and procedures, and so on. As described herein above, Medical Support Databases 30 may be constructed or provided from a variety of sources, and may be accessed, for example, through the Interface Mechanism 20 of the EMR 12 or equivalent mechanisms. Medical Support Databases 30 will typically be accessed by operation of and through Support Processes 44, although user inputs through Input Devices 10ID may be used to directly access Medical Support Databases 30 in certain circumstances.

It will be appreciated and understood by those of ordinary skill in the relevant arts that Process Forms 40 and Medical Records 28R may be constructed, maintained and accessed by means of, for example, an Interface Form Editor 20E of an Interface Mechanism 20 of an EMR 12, or by similar mechanisms. It will also be appreciated and understood by those of ordinary skill in the relevant arts that Support Processes 44 and Medical Support Databases 30 may be implemented in a variety of forms and by use of a variety of utilities or tools, including an Interface Form Editor 20E of an EMR 12 as the Interface Mechanisms 20 of many EMR 12s support at least some degree of programming capability.

In this regard, Support Processes 44 and Medical Support Databases 30 may be constructed as separate entities, that is, as a library of processes, programs or routines for performing Process Operations 32O and as one or more databases containing information extracted from current medical practice guidelines or recommendations that is accessed as required by the Support Processes 44. As discussed, the information included in Medical Support Databases 30 may include, for example, ranges or values of biological measurements, such as blood pressure, lipid levels or frequency and severity of asthma attacks that represent, according to current medical guidelines, either acceptable ranges or ranges indicating a diagnosis of a condition to be treated, guidelines for medications and medication levels, guidelines for tests or other procedures, including guidelines as to the frequency of tests and procedures, and so on. This method for implementing Support Processes 44 and Medical Support Databases 30 is generally advantageous in allowing Support Processes 44 and Medical Support Databases 30 to be readily and independently modified, updated or extended as needed. A disadvantage of this method, however, is that the construction of Support Processes 44 and Medical Support Databases 30 is by processes more familiar to a programmer than to a medical practitioner, and that is thereby distanced from the methods and patterns of thought and practice of the medical practitioner, who is the primary user of the system and the primary source of information regarding the procedures that are to be implemented in Medical Support Processes 10MSP.

For the above reasons, Support Processes 44 and Medical Support Databases 30 are implemented in a presently preferred embodiment of DS/ERS 10 in a form and by a procedure that more closely reflects the methods and patterns of thought and practice of the medical practitioner. For this reason, Support Processes 44, Process Forms 40 and Medical Support Processes 10MSP may be readily constructed by persons whose primary training and experience are in the medical rather than in programming, while is advantageous in that the Medical Support Processes 10MSP more closely reflect actual medical practice. More specifically, Support Processes 44 are presently implemented as sequences of “if-then-else” programs or procedures while and the data of Medical Support Databases 30 is integrated directly into the “if-then-else” statements, or into Fields 42 or “windows” of Process Forms 40.

Lastly, it will be noted that it is common for medical practitioners to use variant forms or terms in referring to, for example, a procedure, measurement, test, medication or condition. The specific form or term used by a practitioner may depend, for example, upon the age and experience of the practitioner, when and where the practitioner attended medical school or subsequently practiced, and so on. For this reason, a DS/ERS 10 of the present invention may further include a Dialect Translator 50 operating in conjunction with Interface Mechanism 20 to translate between terms and forms used by a given practitioner and a common, standard or standardized set of terms and forms. Dialect Translator 50 includes a Dialect Text File 50D for each practitioner using a given DS/ERS 10 wherein the Dialect Text File 50D contains standardized terms and forms as used in Process Forms 40 and wherein the Dialect Text File 50D is indexed by terms and forms specified by or for a given practitioner. Dialect Translator 50 receives terms and forms entered by that practitioner through Input Devices 10ID, and provides the corresponding standard term or form. Dialect Translator 50 also operates in the reverse by reading standard terms and forms appearing in Process Forms 40 and translating the standard terms and forms into the dialect terms and forms preferred by the practitioner in the Process Forms 40 as displayed to the practitioner through Display 10DS.

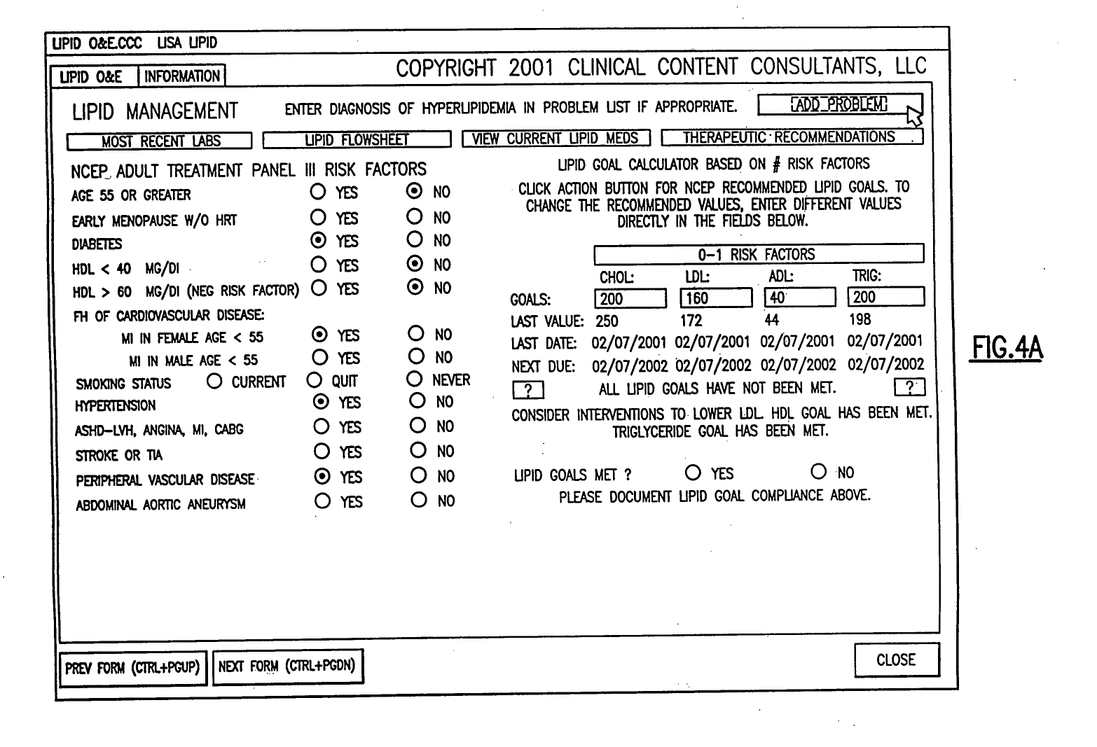

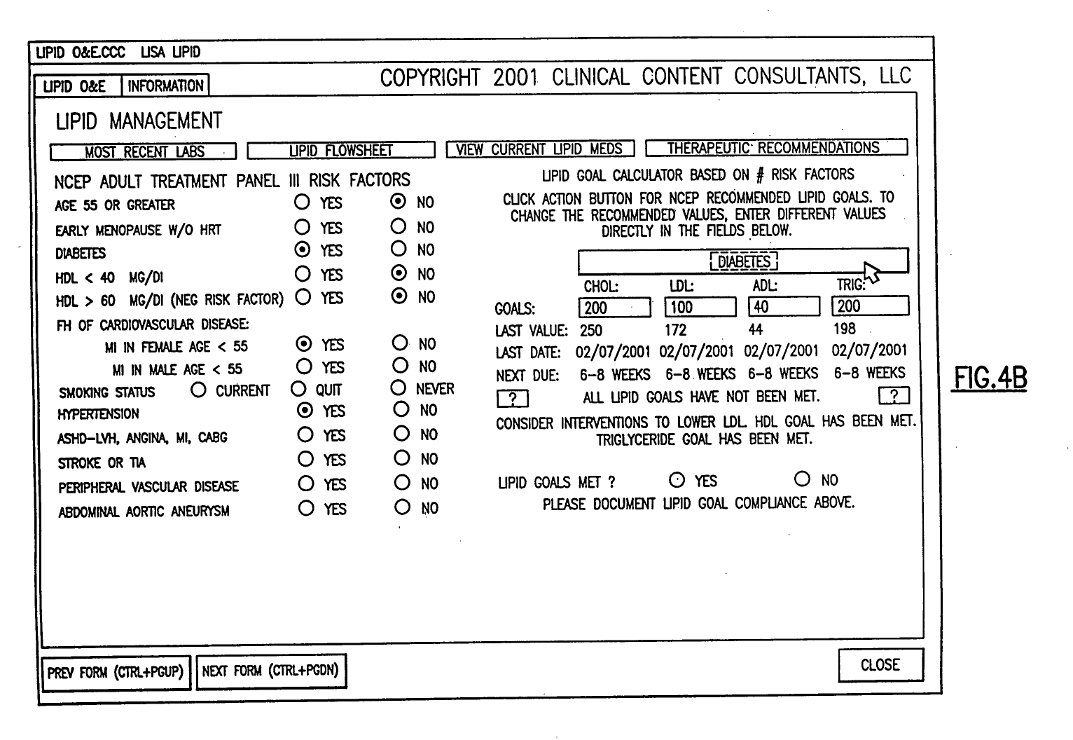

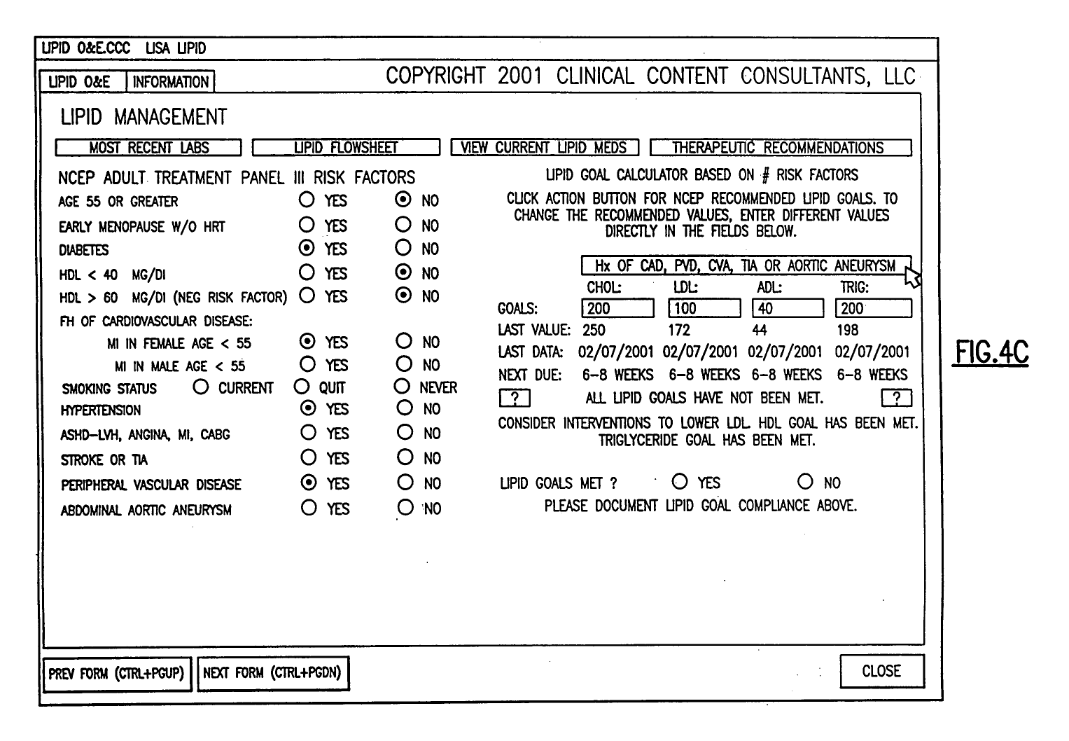

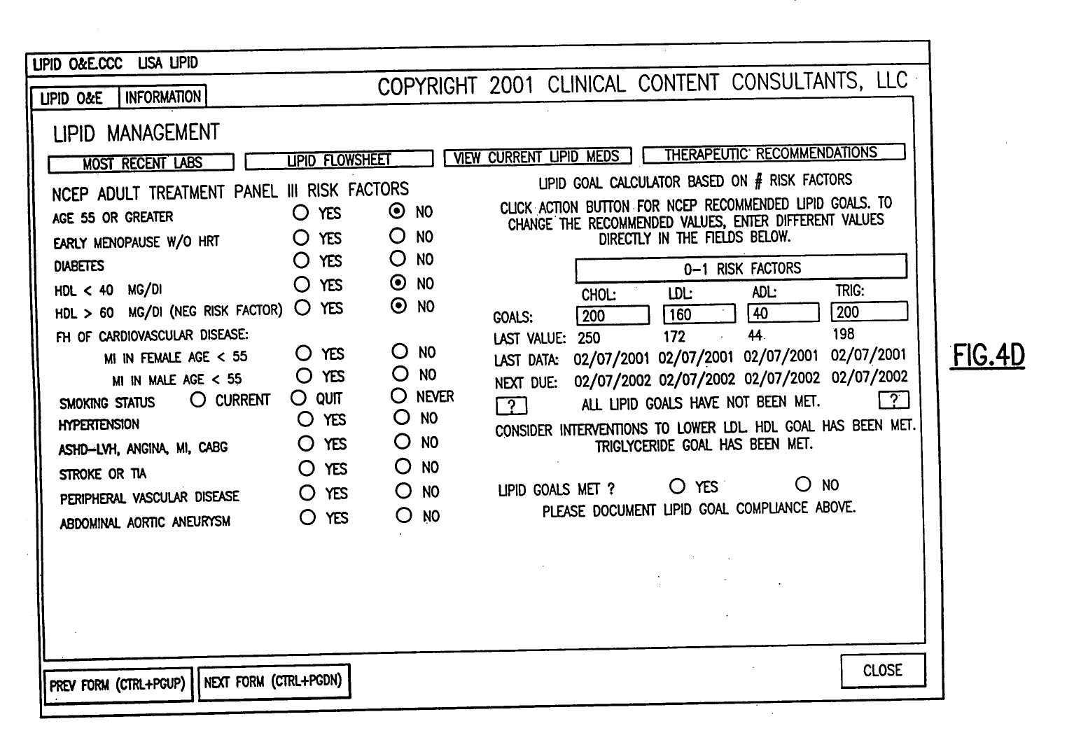

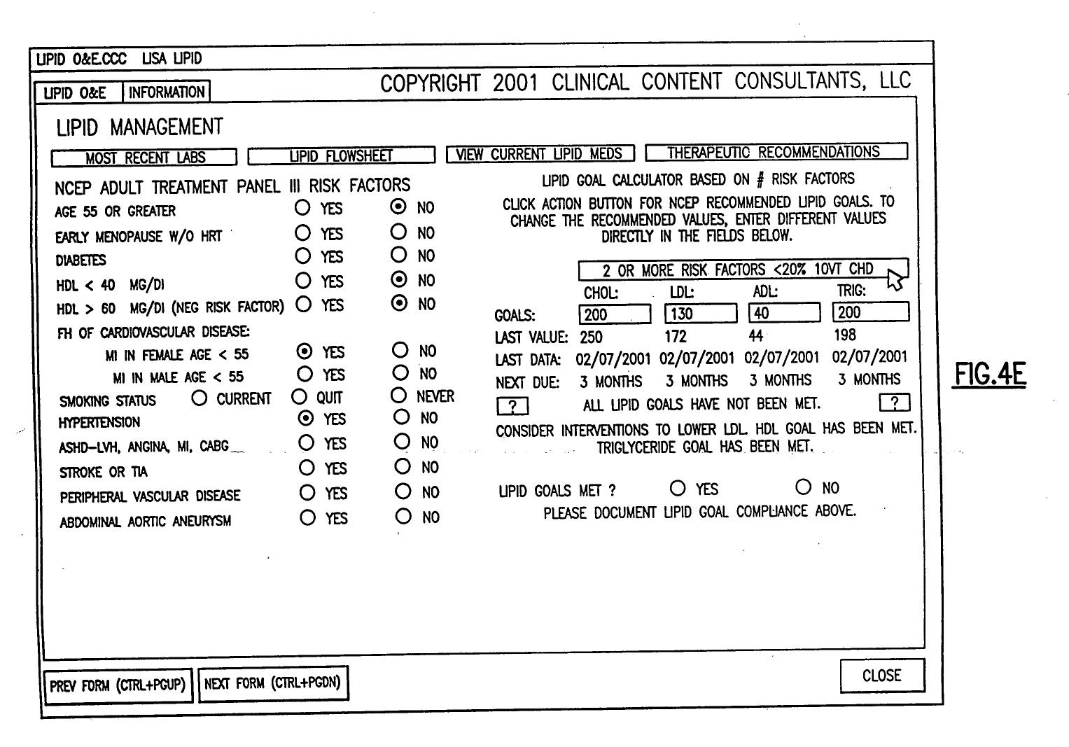

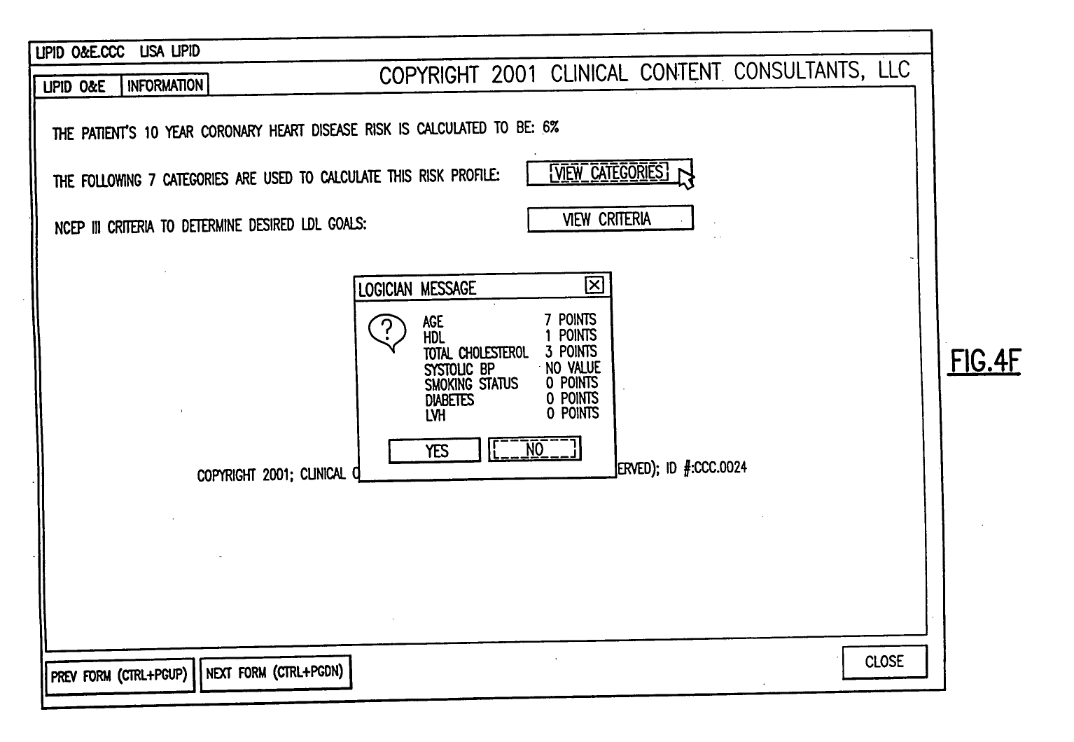

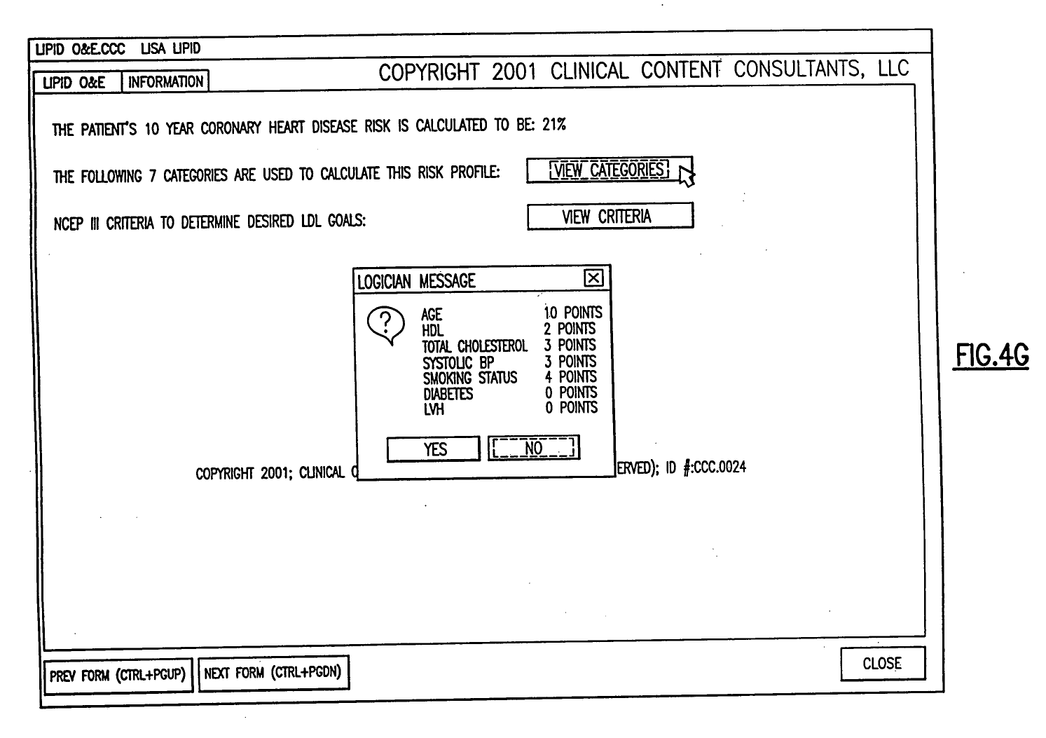

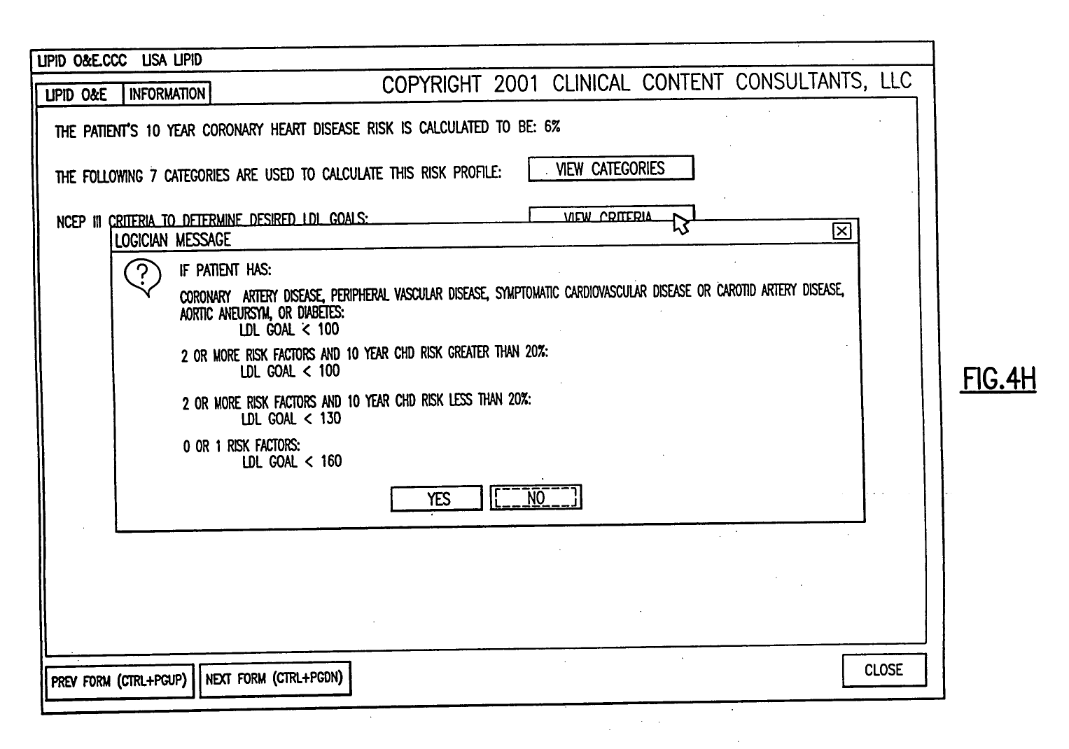

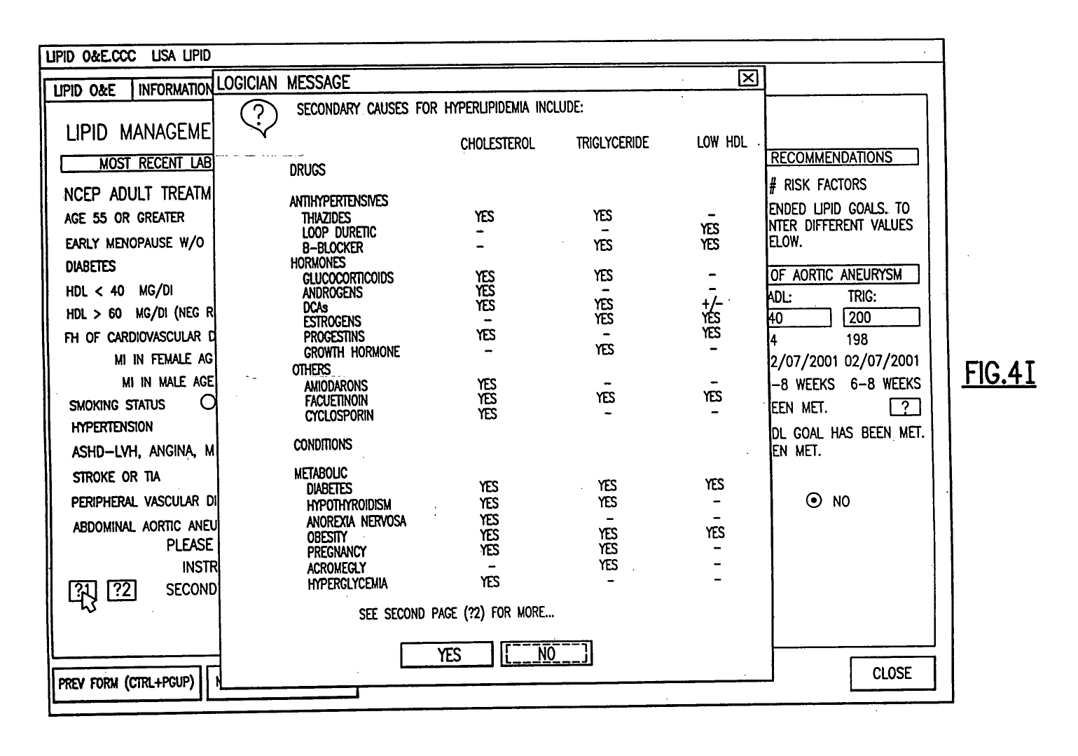

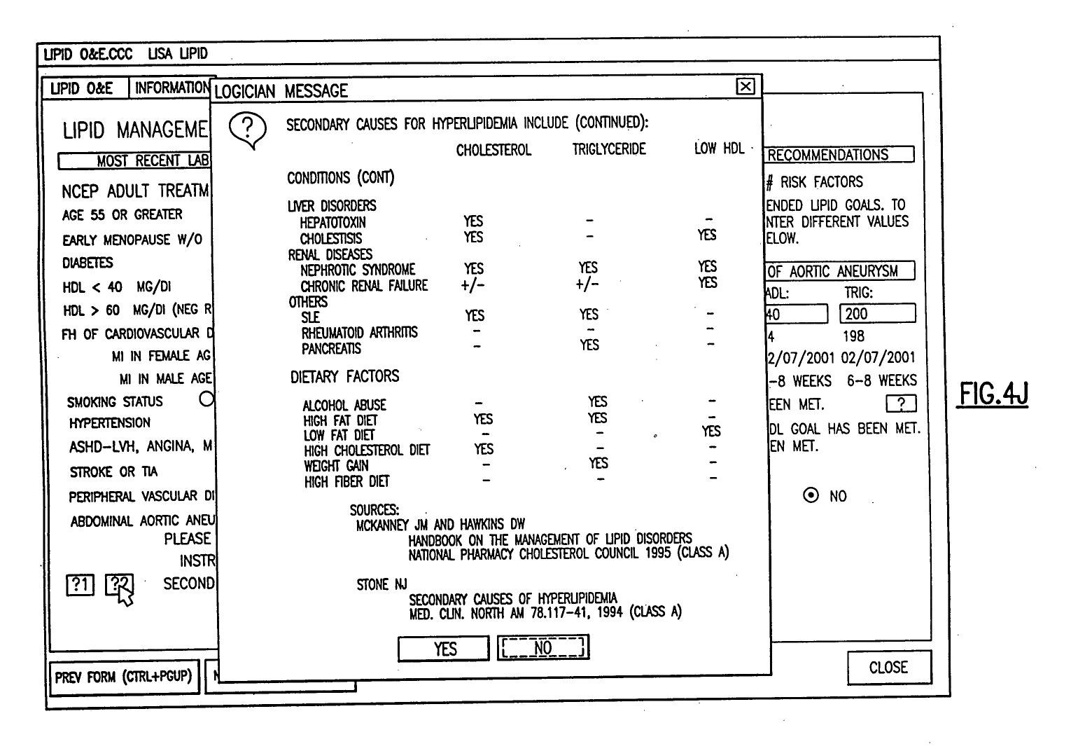

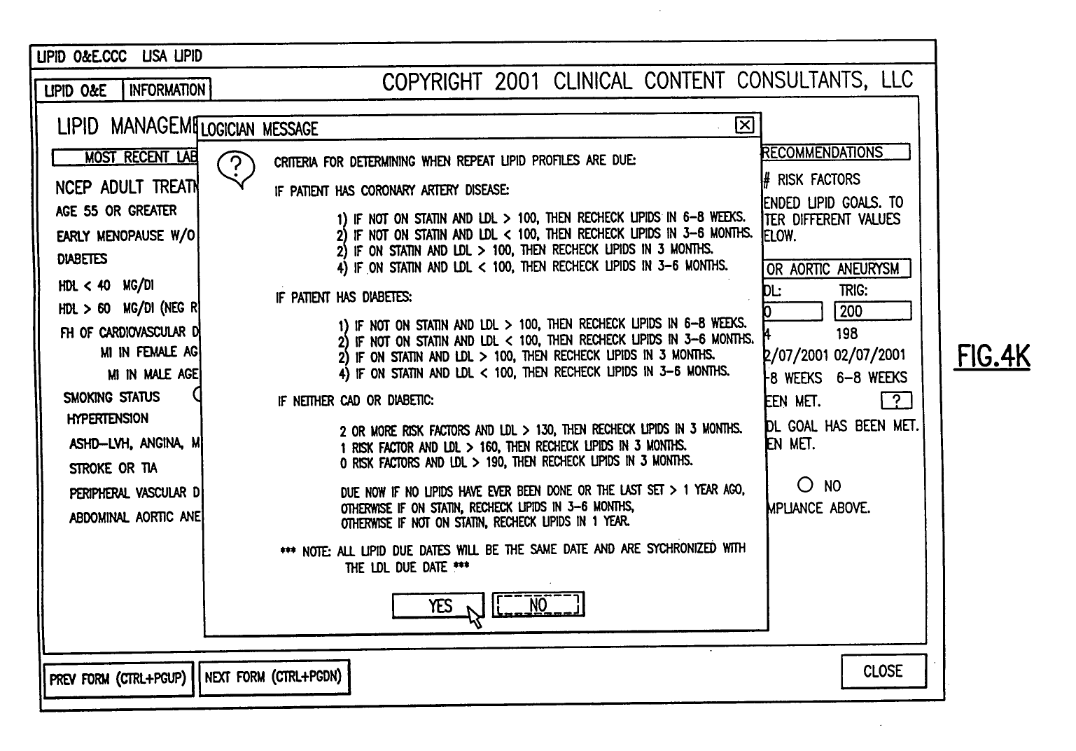

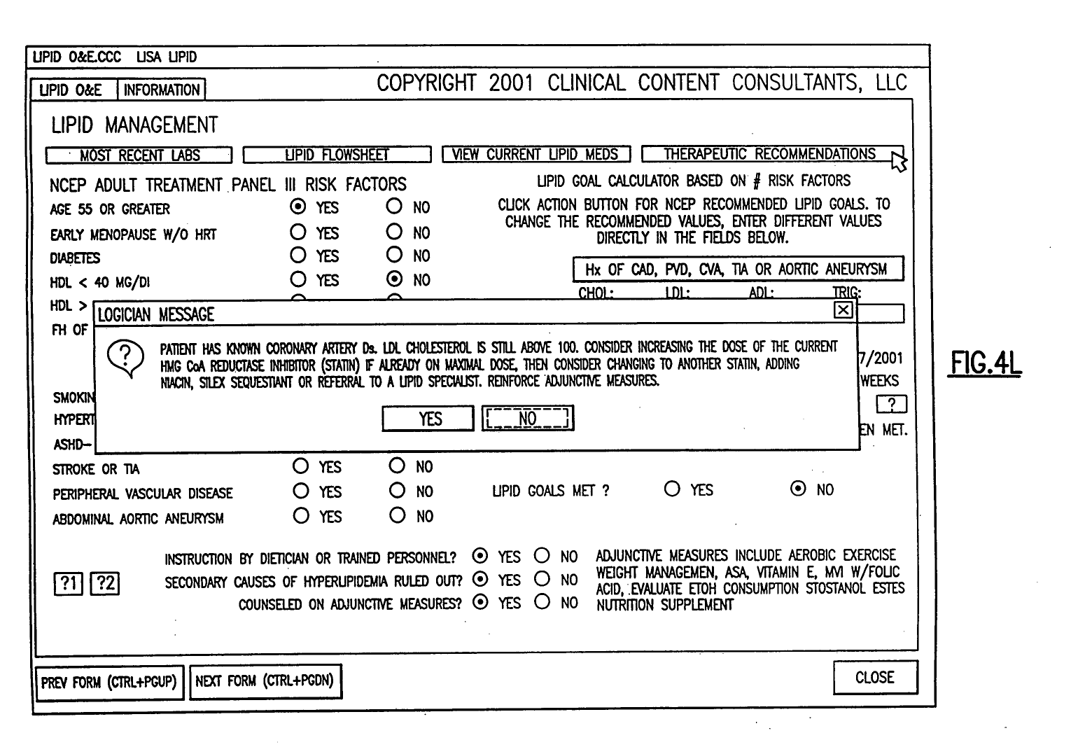

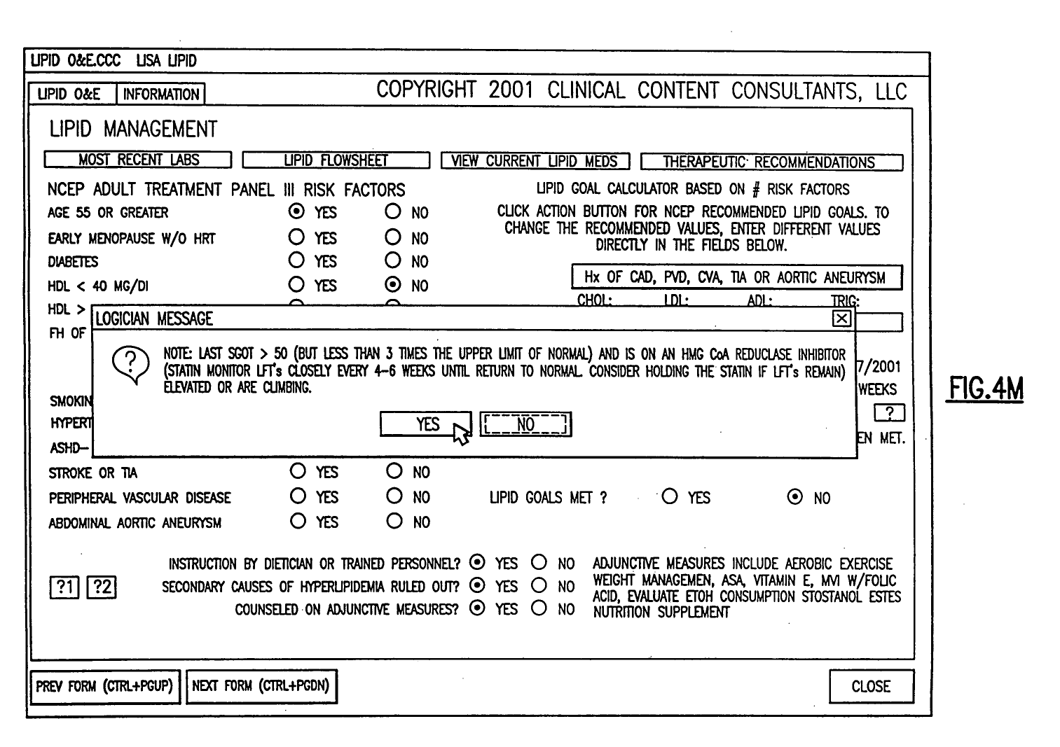

Lastly, in this regard, FIGS. 4A through 4B comprise illustrations of Process Forms 40, the Fields 42 and Process Fields 46 of the Process Forms 40, and Support Processes 44 of an exemplary Medical Support Process 10MSP and, in particular, a Medical Support Process 10MSP for the monitoring and control of lipids, which is a generally recognized significant medical problem. In FIGS. 4A through 4M, FIGS. 4A through 4K illustrate the Process Forms 40 of a Process Phase 32 in which the Data Phase 34 and Diagnostic Phase 36 of the Medical Support Process 10MSP are interleaved, but which begins with Process Forms 40 primarily directed to Data Phase 34 processes and shifts toward Diagnostic Phase 36 processes. For example, and it will be noted that each of these Process Forms 40 contains fields for displaying and entering information relating to the patient, such as age, related conditions or diseases, current cholesterol, LDL, HDL and triglyceride levels, and goal cholesterol, LDL, HDL and triglyceride levels, either as yes/no decisions/data or as numeric data, and so on. In FIG. 4A, for example, the user is prompted to enter a diagnosis of hyperlipidemia to the patient problem list, if appropriate. In FIG. 4B the user requests the current professional guidelines for cholesterol, LDL, HDL and triglyceride levels if the patient is diabetic, and in FIG. 4C repeats the process of Step 4B for additional risk factors. In FIG. 4D the user requests that the patients most recent lab measurements be displayed, for example, for comparison with the guideline cholesterol, LDL, HDL and triglyceride levels, and in FIG. 4E the user requests the cholesterol, LDL, HDL and triglyceride level guidelines for the patient's current risk factors. In FIGS. 4F and 4G, the user requests information pertaining to the diagnosis steps performed in FIGS. 4A through 4E by requesting information regarding the categories of risks that were used in determining the patient risk profile. FIGS. 4F and 4G respectively illustrate the system responses for CV risk factors of 6% and 21%, and in FIG. 4H the Medical Support Process 10MSP provides the user with a message further explaining the risk factors. In FIGS. 4I and 4J the user and support process have reverted to the Process Form 40 illustrated in FIG. 4A, but which is now modified to provide user prompts/reminders as to whether the user has considered other causes of hyperlipidemia and, upon query by the user, displays two message pages of information relating to secondary causes of hyperlipidemia, wherein the user can enter information regarding those factors considered by the user. FIG. 4K continues this process by providing criteria for recommended periods or intervals for repeated lipid profiles for various conditions. In FIGS. 4L and 4M, the Medical Support Process 10MSP enters a Recommendations Phase 38 wherein the Medical Support Process 10MSP provides messages containing therapy or treatment/medication recommendations based on current professional guidelines and the patient information and diagnosis that were entered or reached in the Data Phase 34 and Diagnosis Phase 36 illustrated in FIGS. 4A through 4J.

Lastly, in this regard, Appendix A to the Specification contains a listing of the “if-then-else” statements comprising the Support Processes 44 for the Medical Support Process 10MSP, illustrated in FIG. 4, as an exemplary implementation of a Medical Support Process 10MSP.

In summary, therefore, and as illustrated and described herein above, a system and method of the present invention include or employ medical records relating to the patients and medical support databases including medical guidelines for the diagnosis and treatment of medical conditions according to current professional guidelines for the diagnosis and treatment of diseases and medical conditions and processes utilizing these databases to diagnose and recommend therapy or treatment for a patient in a manner that is supportive of but that does not interfere with the work and mind flow processes of the user. As described, a support process performed by a medical support system of the present invention executes an interactive dialogue between the medical support process and the user to provide guidance to the user in performing the medical support process according to the guidelines and dependent upon the user inputs and the medical record. A medical support process performed by the present invention for a given condition or disease includes one or more process phases, which may include a data entry and review phase, a diagnostic phase and a therapeutic/treatment recommendations phase, which are presented to a user through process forms providing graphic interfaces for the entry and display of information regarding the support process.

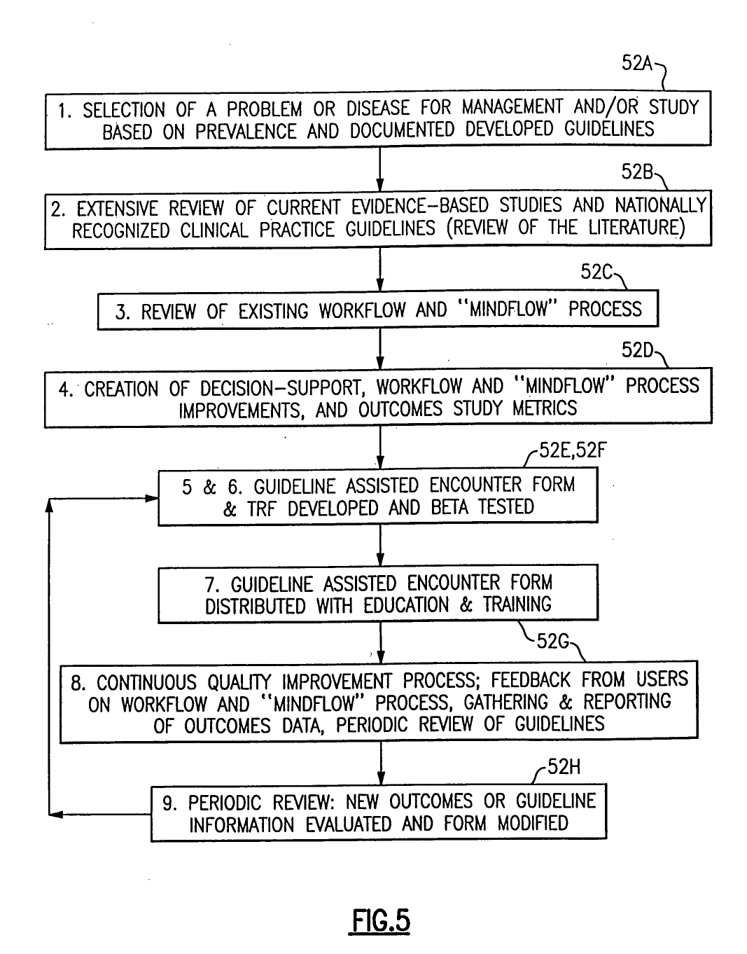

Finally, the procedure for constructing a Medical Support Process 10MSP is illustrated in FIG. 5 and includes the steps of:

Step 52A: Selection of a problem or disease for management and/or study.

The process of designing a guideline-assisted Medical Support Process 10MSP requires selecting a problem or disease to be the subject of the Medical Support Process 10MSP. This step may be based upon evidence-based nationally recognized and published clinical practice guidelines or upon a selected local, regional, or private criteria.

Step 52B: Review of current evidence-based studies and nationally recognized clinical practice guidelines, including review of the literature.

An extensive review of the literature provides the foundation for developing consensus current professionally accepted guidelines pertinent to the subject of the Medical Support Process 10MSP and creating of the guideline-assisted Medical Support Process 10MSP. For example, the Agency for Healthcare Quality Research (AHQR) is presently the overseer of the National Guidelines Clearing House and, for example, can serve as a starting point. Peer review journals with evidence-based outcome studies may also be sources of guideline criteria.

Step 52C: Review of existing workflow and “mind flow” process.

The day-to-day, step-by-step workflow required in the evaluation and treatment of the chosen problem or disease is mapped out for the average provider and practice and the thought process of the provider and patient are studied to map out the most time efficient entry and display of information, guideline prompts, and clinical decision support.

Step 52D: Creation of decision-support, workflow and “mind flow” process improvements, and outcome study metrics.

Based on the evaluation of information gathered in Step 50C on the problem or disease and existing work flows, improved work flow and “mind flow” processes are developed to be implemented in the Medical Support Process 10MSP, as are the quality and outcome study metrics to be incorporated into the Medical Support Process 10MSP.

Step 52E: Development of a guideline-assisted Medical Support Process 10MSP.

Step 52E-1: A “shell” Medical Support Process 10MSP is developed which includes all Process Operations 32O and Process Forms 40, the quality and outcome study metrics, and the enhanced workflow and “mind flow” processes.

Step 52E-2: A range and variety of decision support prompts are reviewed to provide the most efficient and timely but least intrusive assistance, including, for example, data displays, visibility regions and modal dialogue boxes, and the most effective are incorporated into the Medical Support Process 10MSP.

Step 52E-3 The work flow and “mind flow” of the Medical Support Process 10MSP are reevaluated and the Medical Support Process 10MSP is preferable then tested in real clinical practices with real patients and any corrections or modification indicated as a result of the tests are incorporated into the Medical Support Process 10MSP.

Step 52F: Development of a Recommendations Phase 38.

As described and depending on the problem, condition or disease addressed by the Medical Support Process 10MSP, a Recommendations Phase 38 may not be necessary or could be an extensive supplement to the Medical Support Process 10MSP. As described, in those instances where a Recommendations Phase 38 is required, Steps 52E will include the additional Step 52F of constructing a Recommendations Phase 38 which, as described, is constructed as Process Operations 32O based on series or strings of “if-then-else” statements that evaluate past and current patient specific information from the databases, patient demographics, such as age, sex, height, weight, and so on, problems particular and specific to the patient, current and previous medications, allergies, lab values, that is, the results of laboratory tests and procedures, and patient specific observations, such as whether lipid goals have been met, and so on.

Step 52G: User Review.

Each Medical Support Process 10MSP is continuously reviewed on the basis of information from users of the Medical Support Process 10MSP, and is modified as indicated by information from the users.

Step 52H: Guideline Review.

The guidelines and current recommended medical practices incorporated into each Medical Support Process 10MSP are continuously reviewed from all available sources and changes in the accepted and recommended guidelines and practices are incorporated into each Medical Support Process 10MSP as the recommended guidelines and practices are updated.

B. Voice Control/Navigation/Data Entry System

According to the present invention, a Decision Support/Electronic Record System (DS/ERS 10) of the present invention, such as the exemplary medical support system discussed herein above, employs a voice control/navigation/data entry system of the present invention to provide all DS/ERS 10 inputs and functions that would otherwise be provided by conventional input devices, such as keyboards and mice. As implied by the name, a voice control/navigation/data entry system of the present invention, the voice input system of the present invention recognizes voice inputs to control all functions of the DS/ERS 10, to control navigation through the functions and features of the DS/ERS 10, and for all data and information input to the DS/ERS 10.

A voice control/navigation/data entry system of the present invention is constructed around a voice recognition engine of the general types presently known and available. As has been discussed, however, current voice recognition engines, in their present form, suffer from lack of speed and accuracy and excessive learning times primarily because current voice recognition systems are functionally overloaded and are not developed primarily for ER/EMR application functionality or ease of use. That is, and as discussed, current voice recognition engines typically first attempt to recognize and accurately identify the various phonemes comprising human speech as spoken by a specific user, and then attempt to recognize the combinations of identified phonemes as words. There are usually some 42 commonly recognized phonemes and obviously a very wide range of pronunciations of each phoneme due to various accents, languages and so on, as well as a potentially immense vocabulary of combinations of phonemes, that is, words and phrases.

According to the present invention as described herein below, however, a voice recognition engine of the present invention achieves increased speed with enhanced accuracy and reduced training requirements by context dependent speech recognition. For purposes of the present invention, context dependent speech recognition is defined as speech recognition system wherein the vocabulary of words recognized by the system is constrained, at least initially, to the vocabulary naturally and customarily used by the user in performing the dictations, operations and functions to be supported by a DS/ERS 10 in which the speech recognition engine is implemented.

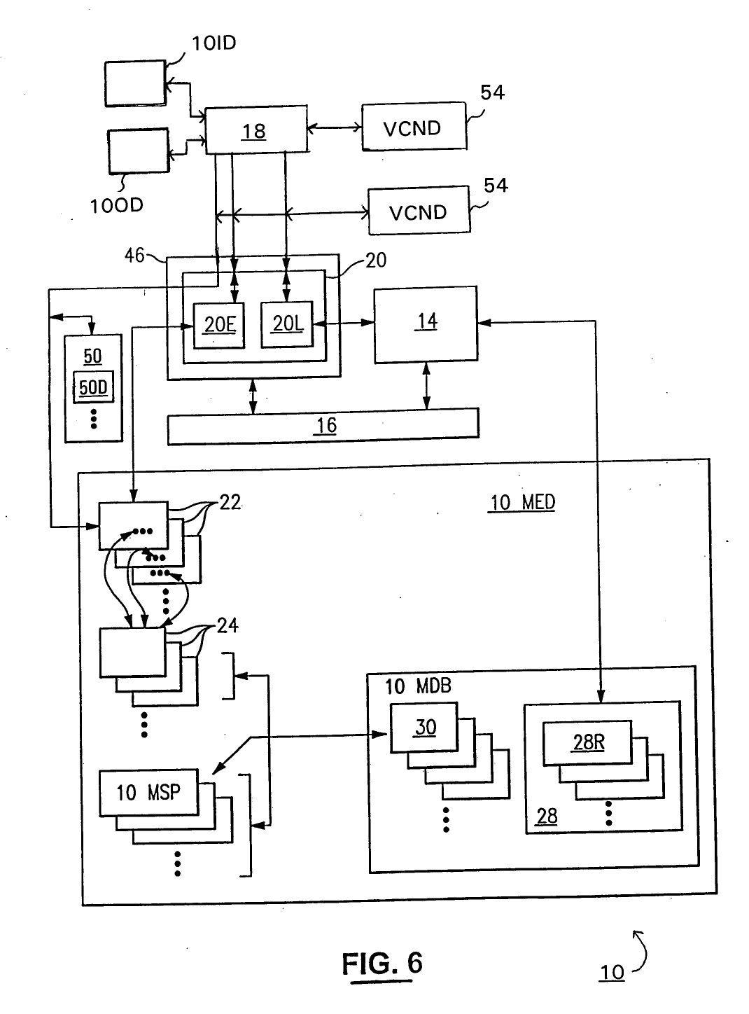

Referring to FIG. 6, therein is shown a diagrammatic representation of a DS/ERS 10 similar in structure, function and operation to that shown in FIGS. 1, 2, 3 and 4A-4M but employing a Voice Control/Navigation/Data Entry System (VCND System) 54 of the present invention. Again, a user may interface and interact with the DS/ERS 10 through a Client Interface 18, which may have local or remote or network communications with conventional Input Devices 10ID, such as a keyboard, mouse or touch screen, and Display Devices 10DS, such as a CRT display. As shown, a VCND System 54 may communicate with the DS/ERS 10 directly or through a Client Interface 18 in a manner analogous to Input Devices 10ID. Like Input Devices 10ID, a VCND System 54 may be local to the Client Interface 18 or VCND System 54, or may be connected thereto through a remote link, such as a wireless connection or a network.

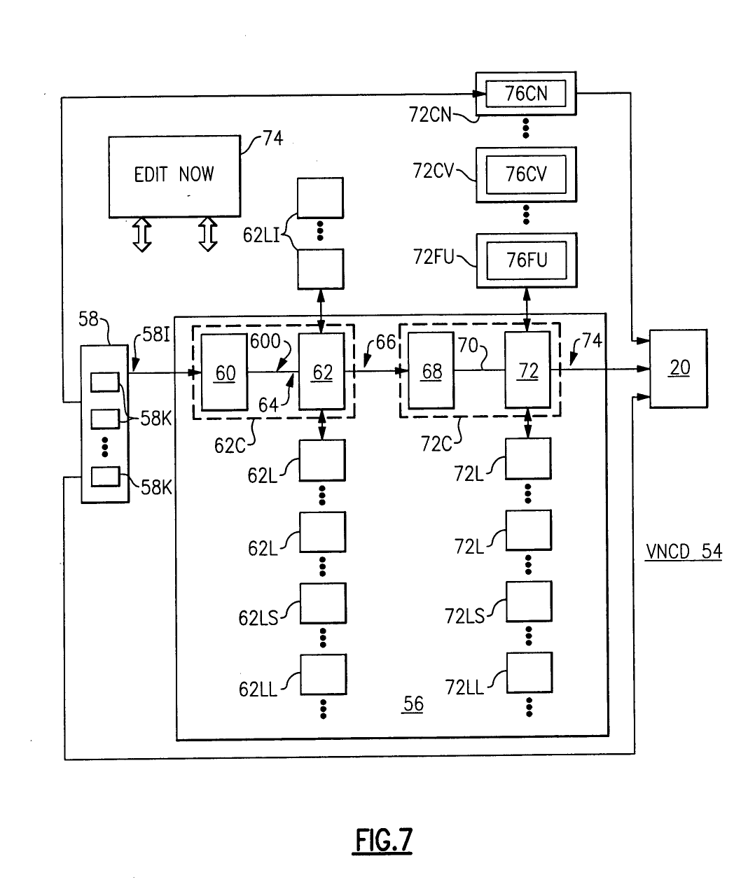

As illustrated in FIG. 7, the core voice recognition mechanism of a VCND System 54 is a conventional Voice Recognition Engine (VRE) 56 such as Scansoft Dragon or IBM Via Voice or any other general purpose voice recognition system of similar capabilities, which is connected from a Voice Input Device 58, such as a microphone, which generates a Voice Input Signal 58I when spoken into by a user. As will be described in the following, however, the fundamental functions and operations of a conventional VRE 56 as employed for core, basic voice recognitions functions in a VCND System 54 of the present invention are fundamentally modified according to the present invention to implement context dependent voice recognition, dictation, commands, controls, functions and workflows in accordance with the present invention.

First considering the Voice Input Device 58, it must be noted that while the primary input to the VCND System 54 is the Voice Input Signal 58I from Voice Input Device 58, the Voice Input Device 58 used in the VCND System 54 is selected from among those microphone devices that include at least a small number of Voice Input Device Keys 58K, or buttons, such as a Philips SpeechMike USB Pro Model 6274. As discussed further below, certain of the Voice Input Device Keys 58K are connected into the DS/ERS 10 through VCND System 54 or directly through Interface Mechanism 20 and in parallel with or in place of the keyboard and mouse of User Input Devices 10ID.

According to the present invention, Input Device Keys 58K operate in parallel with or in place of certain basic control inputs normally provided from a keyboard or mouse, such as the TAB or Enter keys of a keyboard or the right and left buttons of a mouse, that are commonly employed in the control/navigation functions of a system. In particular, certain of the inputs from Input Device Keys 58 are transformed into more complex control/navigation inputs, such as “macros” for selecting a next or previous space for data or text entry on a form or selecting a next form of a sequence of forms, as has been discussed herein above with regard to DS/ERS 10.

The combination of a voice input device with a selection of basic control/navigation Input Device Keys 58K into the single Voice Input Device 58 in conjunction with the VCND System 54 of the present invention thereby allows the Voice Input Device 58 to function in replacement for User Input Devices 10ID. It should be noted, however, that many of the basic system keystroke control and navigation inputs, such as “enter” or “tab” key strokes and mouse button clicks may also be generated from the keyboard or mouse or from specific voice commands recognized by the VRE 56.

Next considering the voice recognition functions of the core VRE 56 of a VCND System 54, FIG. 7 is a diagrammatic illustration of the structure, functions and operations of a generalized conventional VRE 56. In this regard, it must be understood that the VRE 56 illustrated in FIG. 7 does not represent any specific conventional voice recognition engine, but is provided to demonstrate and describe the basic and inherent functions and operations of such a conventional VRE 56. For example, in other implementations of a voice recognition engine certain functions or operations described individually in the following may be combined into single operational steps or may be performed using alternate functions or operations or may be represented or described in an alternate manner. It must also be understood that FIG. 7 also illustrates the fundamental differences between a conventional VRE 56 and a VRE 56 adapted for use in a VCND 54 according to the present invention.

As shown, the core VRE 56 includes a Spectrum Analyzer 60 connected from Voice Input Device 56 to analyze Voice Input Signal 58I from Voice Input Device 58 and generate a corresponding Voice Signal Spectrum 60O output representing the frequency, waveform and duration characteristics of the signal components of Voice Input Signal 60I. Voice Signal Spectrum 60O is passed to a Phoneme Identifier 62, which recognizes and identifies Phonemes 64 occurring in Voice Signal Spectrum 60O from their waveform, frequency and duration characteristics as that appear in Voice Signal Spectrum 60I. The Phoneme Identifier 62 generates and passes Phoneme Identifications 66 or sequences of Phoneme Identifications 66, depending upon their occurrence in Voice Input Signal 58I, to a Character Identifier 68.

In this regard, it has been described herein above that a general purpose Voice Recognition Engine (VRE) 56 must recognize and identify a large number of phonemes, characters and words despite a very wide range of pronunciations of each phoneme due to various accents and languages. For these reasons, the Phoneme Identifier 62 will typically include one or more Phoneme Libraries 62L that will contain information identifying the frequency, waveform and duration characteristics of the various phonemes and phoneme variations. Phoneme Identifier 62 will then compare the frequency, waveform and duration characteristics extracted from Voice Input Signal 58I and as represented in Voice Spectrum Signal 60O to the phoneme and phoneme variation definitions stored stored in a Phoneme Library 62L and will generate a Phoneme Identification 66 based on the best match for each possible phoneme identified in Voice Spectrum Signal 60I.

For these purposes, therefore, a Phoneme Library 62L will typically contain variations of at least certain phonemes, or, expressed another way, ranges of definitions or variations for at least certain phonemes, and will usually have sufficient capacity to deal with expected regional or linguistic variations on the pronunciations of the phonemes. The basic Phoneme Library 62L will typically have sufficient capacity, or may be extended by the addition of, for example, one or more Phoneme Learning Libraries 62LL, to allow the Phoneme Identifier 62 to be “taught” to recognize the voices of specific user's by recognizing the phonemes representing the individual characteristics of a user's accent, pronunciation and manner of speaking.

It should also be recognized that the identification of phonemes in a voice signal may be performed through a number of alternate processes to yield essentially the same result, that is, a Phoneme Identification 66 or a sequence or group of Phoneme Identification 66 representing the Phonemes 64 appearing in the voice signal. For example, and given the decreased cost and greatly increased sizes of storage space, the functions of Spectrum Analyzer 60 and Phoneme Identifier 62 may be combined into an integrated Phoneme Identification Mechanism 62C. That is, and for example, the Phoneme Identification Mechanism 62C, or an equivalent, may extract a continuous running sample of the actual waveform of Voice Input Signal 58I by means of a “sample window” moving continuously in time along Voice Signal 58I. The successive Voice Signal 58I samples may then be compared to stored representations of the waveforms of phonemes and phoneme variants stored in a Phoneme Library 62L and a Phoneme Identification 66 generated when a voice signal sample matches a stored representation of a phoneme or phoneme variant to within a predetermined tolerance, or allowable range of variance.

As indicated in FIG. 7, the Phoneme Identifications 66 and sequences of Phoneme Identifications 66 generated by Phoneme Identifier 62 are parsed and identified by a Character Identifier 68 to provide an output comprised of corresponding Character Identifications 70 and sequences of Character Identifications 70. Each Character Identification 70 may correspond to a Phoneme 64 or to a sequence or group of Phonemes 64, and a Character Identification 70 will typically represent a character, letter, number, or sequence or group of characters, letters or numbers in some order.

As indicated, Character Identifier 68 will often include a Character Library 68L that relates Phonemes 64 or sequences or groups of Phonemes 64, as represented by Phoneme Identifications 66, into their text symbol equivalents. Stated another way, Character Identifier 68 essentially translates or transforms the sounds represented by the phonemes or sequences or groups or combinations of phonemes in the voice signal into their equivalent text symbol representations. It will be understood, in this regard, that Character Identifiers 68 will often be expressed as standard codes, such as the ASCII text codes, or in special, unique or proprietary codes or any mix thereof.

The Character Identifications 70 and sequences or groups of Character Identifications 70 are provided to a Word Generator 72 which parses the Character Identifications 70 and sequences or combinations of Character Identifications 70 into character combinations comprising possible Words 74. Word Generator 72 then identifies which of the Character Identifications 70 and sequences or combinations of Character Identifications 70 comprise Words 74 as defined within the vocabulary and context of Words 74 recognized by the VCND 54. Word Generator 72 then provides the Words 74 to Interface Mechanism 20 as the voice control/navigation/data entry input to the DS/ERS 10.

In this regard, it must be noted and understood that each Word 74 will typically be a predetermined keystroke, combination or sequence of keystrokes or their equivalent text symbols comprising a word, phrase, character, letter, number, symbol, command or instruction or a sequence or combination of any of such in any order. As described further below, a Word 74 may also be generated by the appearance of a specific control or command signal provided from a source other than through Voice Signal 58I and the operations of the VRE 56, such as from Input Device Keys 58K.

It must also be recognized that, as in the instance of phoneme identification wherein spectrum analysis and phoneme identification may be combined into a single phoneme identification mechanism, Character Identifier 68 and Word Generator 72 by be combined into an integrated Word Identification Mechanism 72C. That is, and for example, the Word Identification Mechanism 72C would receive Phoneme Identifications 66 from Phoneme Identifier 62 or Phoneme Identification Mechanism 62C and would directly detect and identify those phonemes or sequences or combinations of phonemes comprising Words 74 as defined within the vocabulary and context of Words 74 recognized by the VCND 54.

It has been described herein above that a general purpose Voice Recognition Engine (VRE) 56 must recognize and identify an extremely large vocabulary of words, phrases and instructions or commands and must do so despite a very wide range of pronunciations of each word or phrase due to various accents, and languages, a multiplicity of general purpose and specialized vocabularies, and a potentially immense vocabulary of combinations of phonemes, or words. It is because of these requirements that, as discussed above, a Phoneme Identifier 62 will typically include one or more Phoneme Libraries 62L to allow identification of phonemes over a wide range of accents and user voices.

In a like manner, and for the same reasons, a Word Generator 72 will typically include one of more Character Libraries 72L for use in translating Character Identifications 70 and sequences or groups of Character Identifications 70 into the corresponding words, phrases, commands, instructions and so on of Words 74 and sequences or groups of Words 74. For this purpose, a Character Library 72L will contain definitions and allowable variations of a vocabulary or words, characters, commands, instructions, phrases and so on that the system is intended or expected to recognize. In general, a Character Library 72L will have sufficient capacity to deal with the expected vocabulary of words, phrases and so on expected to be used by the average user of the system. In addition, the capacity and vocabulary of Character Libraries 72L of a VRE 56 may typically be extended by the addition of supplemental and Special Purpose Character Libraries 72LS. Scansoft Dragon, for example, has a medical terms extension that may be added to the basic, general purpose vocabulary of the basic Character Library 72L.

As also indicated in FIG. 7, the Character Library 72L of a VRE 56 can often be further extended by means of Character Learning Libraries 72LL for storing, for example, additional vocabulary words “taught” to the VRE 56. In general, Character Learning Libraries 72LL, like Phoneme Learning Libraries 62LL, are the means by which the system “learns” and adapts to new words, phrases or commands and is the means by which the system vocabulary is expanded to meet specific uses.

It should also be noted that Phoneme Learning Libraries 62LL and Character Learning Libraries 56 may exist, for example, as additional storage space within the Phoneme Libraries 62L or Character Libraries 72L, or may be separate libraries. As discussed, however, while such extensions as Phoneme Learning Libraries 62LL, Special Function Character Libraries 72LS and Character Learning Libraries 72LL increase the capabilities and flexibility of the VREs 56, such extensions also generally increase the processing times and the error rates of the VREs 56.

In summary, therefore, a conventional VRE 56 interprets and transforms a user's voice input into the equivalent of text keystroke inputs from a keyboard. The user's voice input is thereby essentially used only in speech to text conversion in replacement for and in the same manner as text input from a keyboard, with other control and navigation command inputs being provided from the keyboard and mouse in the usual manner.

Next considering the adaptation of a conventional VRE 56 according to the present invention, it has been described herein above that a conventional, core VRE 56 as used for basic speech recognition functions in a Voice Control/Navigation/Data Entry System (VCND System) 54 of the present invention is provided with certain fundamental modifications and adaptations for this purpose. As described herein above, a VCND System 54 of the present invention employs context dependent speech recognition wherein the speech recognition functions and capabilities are constrained and focused to the context of the operations and functions supported by the DS/ERS. Stated another way, and according to the present invention, context dependent speech recognition constrains and focuses the speech recognition functions to the vocabulary naturally and customarily used by the user in performing the operations and functions to be supported by the DS/ERS 10 when the VCND System 54 is being employed for its intended purpose. In addition, the capabilities of the VCND System 54 are extended beyond straightforward speech to text conversion in a manner that is directly related to and enhances the functions performed by the user and supported by the DS/ERS 10.

For example, and as described further below, according to the present invention a conventional VRE 56 is in part adapted to context dependent speech recognition according to the present invention by means of specific purpose, focused additions to the basic Character Libraries 72 and Phoneme Libraries 62L of the VRE 56, often in replacement of the general purpose Character Libraries 72 and Phoneme Libraries 62 ordinarily provided with a conventional VRE 56.

In addition, and as discussed above with respect to Voice Input Device 58, a VCND System 54 of the present invention employs the otherwise relatively unused keys/buttons available on certain microphones in replacement of, or as an alternative to, for example, the tab and enter keys of a keyboard or the right and left buttons of a mouse. In particular, and according to the present invention, certain of Input Device Keys 58K are employed for control/navigation inputs specific to the functions and purposes of the DS/ERS 10, such as selecting a next or previous space for data or text entry on a form or selecting a next form of a sequence of forms, as has been discussed herein above with regard to DS/ERS 10.

In addition, a VCND System 54 will include command/navigation translation modules which will contain macros or sub-routines or their equivalent to transform certain Character Identifications 70 and sequences or groups of Character Identifications 70 into complex control/navigation keystroke input sequences similar in many respect to conventional “macros”.

First considering the modifications of the present invention to the basic Phoneme Libraries 62 and Character Libraries 72, it is recognized by the present invention that the individual users of a DS/ERS 10 the VCND System 54 comprise a significant part of the system “context”. According to the present invention, the VCND 54 may therefore include a Phoneme Learning Libraries 62LL or a portion thereof, for each individual user of the system, identified in FIG. 7 as Individual Phoneme Libraries 62LI, thereby allowing the VCND System 54 to “learn” the individual characteristics of each user's voice and manner of speaking. The total number of customary or authorized users will typically be limited, so the range of phoneme variations that must be identified will typically be correspondingly reduced from the range of variations that must be identified in a fully general purpose system, thereby increasing the speed and accuracy of the system. If, in addition, a specific current user of the DS/ERS 10 and VCND System 54 is identified to the VCND System 54 while that user is using the system, the range of phoneme variations that must be identified will be still further reduced to the range characteristic of the identified user as represented in the Individual Phoneme Library 62LI specific to that user.

The reduction in the range of variation in phonemes that must be recognized by the VCND System 54 when operating with a given user to only the range of phoneme variations characteristic of that user thereby reduces the workload on the VCND System 54, thereby increasing the speed and accuracy of the system. It should also be noted that this method allows a comparison of the speech input of an identified user with the stored phoneme characteristics of that user may provide additional system security and the detection of when an identified user's actual speech does not correspond to the stored user phoneme characteristics, which provides a degree of security for the system.

Finally, it should be noted that the VCND 54 will typically also retain the general purpose Phoneme Library 62L or Phoneme Libraries 62L provided with the VRE 56 for use during training for a new user and for use by others than the identified and authorized users when necessary. In the presently preferred embodiment, however, the general purpose Phoneme Library 62L or Phoneme Libraries 62L, or at least portions thereof, will preferably be disabled or otherwise locked or switched out of operation during normal use by a user represented in an Individual Phoneme Library 62LI, so that the system operates from the Individual Phoneme Library 62LI rather than from the general purpose phoneme libraries.

Next considering Character Libraries 72L, the Character Libraries 72 of a VCND System 54 of the present invention are likewise modified according to the present invention for the purposes of context dependent speech recognition. For example, rather than identifying Characters 70 by reference to a very large general purpose vocabulary residing in a general purpose Character Library 72L, the VCND 54 will include a Field of Use Character Library 72FU storing a Field Of Use Vocabulary 76FU comprised of Words 74 focused on and specific to the field in which the DS/ERS 10 is to function. In the instance of a medical support DS/ERS 10 as described herein above, for example, the Field Of Use Vocabulary 76FU will be directed to medical terms and phrases. In this regard, it should be noted that Field Of Use Character Library 72FU and Field Of Use Vocabulary 76FU may be created specifically for a given DS/ERS 10, or may be adapted from a commercially available voice recognition program. For example, a VCND System 54 for a medical support DS/ERS 10 that is employing Scansoft Dragon, for example, may employ the medical terms extension library that is available for use with Scansoft Dragon.

In addition, the Character Libraries 72L of a VCND 54 will typically also include a Common Vocabulary Library 72CV storing a limited Common Vocabulary 76CV comprised of common words that are useful and used in the field in which the DS/ERS 10 operates, including such common words as “the”, “a”, “and”, “or” and so on. Common Vocabulary 76CV and Common Vocabulary Library 72CV are thereby significantly reduced and limited in size and range from general purpose Character Libraries 72 by the elimination of words and phrases that are not actually necessary for the relatively limited purposes of the DS/ERS 10.

The VCND 54 will typically further include a Command/Navigation Vocabulary 76CN comprised of specialized characters and words or sequences of characters or words, such as macros, specifically relating to the control of operations in the DS/ERS 10 and to navigation through the operations and functions supported by the DS/ERS 10, as described herein above. The Command/Navigation Vocabulary 76CN may include command/navigation translation modules which will contain macros or sub-routines or their equivalent to transform certain Character Identifications 70 and sequences or groups of Character Identifications 70 into complex control/navigation keystroke input sequences similar in many respect to conventional “macros”. Such navigation and control functions and operations have been discussed in detail herein above with respect to the exemplary medical support DS/ERS 10 described herein above, and will not be discussed in further detail herein. Lastly, in this regard, it should be noted that Command/Navigation Vocabulary 76CN or portions thereof may reside in a Command/Navigation Character Library 72CN or, for example, in an area in Common Vocabulary Library 72CV.

Lastly in this regard, it has been described herein above that a VCND System 54 of the present invention employs at least certain of Input Device Keys 58 for control/navigation inputs specific to the functions and purposes of the DS/ERS 10, such as selecting a next or previous space for data or text entry on a form or selecting a next form of a sequence of forms, as well as possible alternatives to the usual “entry” and “tab” keys or mouse buttons. As indicated in FIG. 7, and for this reason, certain of the Input Device Key 58 outputs may be routed to Command/Navigation Vocabulary 76CN to directly invoke corresponding control/navigation keystroke input sequences and functions to Interface Mechanism 20.

C. Examples of Aspects of a Voice Control/Navigation/Data Entry System in a Present Implementation

It will be recognized by those of ordinary skill in the relevant arts that the above described modifications of the present invention to the functions and operations of a may be implemented in a number of ways.

To illustrate, it is well known and understood that a common problem in all DS/ERS's 10 and/or VCND Systems 54 is the effective use of real estate within the graphical user interface (GUI). The more features and functionality the system has, the busier the display fields appear and the more navigation between modules is required, which can result in non-use of the full functionality of the DS/ERS 10 and/or VCND System 54. For example, present implementations of a DS/ERS 10 and/or VCND System 54 of the present invention have been provided with third and fourth-generation EMR functioning graphical encounter forms, which have been clinically proven to improve quality of care and patient outcomes. Unfortunately, these forms require a certain level of sophistication, dedication, and advanced training to navigate around and activate all the features. As such, only 40 to 60% of end-users, for example, ever fully implement the clinical decision-support system forms.

For this reason, and as described herein above, a DS/ERS 10 or VCND System 54 of the present invention incorporates voice-activated functions that allow the provider to accomplish a variety of clinical workflow, clinical decision-support, and quality of care functions through simple intuitive voice commands that ordinarily would have required multiple mouse clicks or keystrokes. For example; instead of having to navigate to a Diabetes graphical counter form, finding the diabetic flow sheet action button, and clicking the action button to activate, the users of a DS/ERS 10 and/or VCND System 54 of the present invention can simply provide the verbal input, from anywhere in an update, of “view diabetes flowsheet” and the diabetes flowsheet pop-up window will appear.

In a present embodiment, for example, the voice activated commands available to a user, and implemented in the DS/ERS 10 and VCND System 54 include:

TABLE 1
Voice Activated Functions

| | |
|---|---|
| View (specify lab set) Labs | Brings up a Windows Pop-up for viewing |
| | most recent labs |
| View lipid labs | Last Cholesterol, HDL, LDL, and TG |
| View diabetes labs | Last HgBA1c, urine microalbumin, |
| | Creatinine, Last Cholesterol, HDL, LDL, |
| | and TG |
| View coumadin labs | Last PT, INR, Hgb, Hct |
| View (specify lab set) | Brings up a Windows Pop-up for viewing |
| Flowsheet | the last four (4) most recent labs |
| View lipid flowsheet | Last four (4) Cholesterol, HDL, LDL, and |
| | TG's |
| View diabetes flowsheet | Last four (4) HgBA1c, urine microalbumin, |
| | glucoses |
| View coumdin labs | Last four (4) PT, INR, coumadin doses |
| Add diagnosis (specify | Adds single diagnosis or opens up custom |
| problem) | problem list then adds to Problem List |
| Add diagnosis UTI | Adds single diagnosis of UTI to Problem |
| | List |
| Add diagnosis hypertension | Opens up hypertension custom list to add |
| | more specific diagnosis to Problem List |
| Add diagnosis GERD | Adds single diagnosis of GERD to Problem |
| | List |
| Add diagnosis diabetes | Opens up diabetes custom list to add more |
| | specific diagnosis to Problem List |
| Order (specify medication, | Opens up medication specific custom list, |
| lab, diagnostic) | lab orders module, or diagnostic testing |
| | orders m odule |
| Order beta-blocker | Opens up beta-blocker custom med list |
| | from anywhere within an update |
| Order statin | Opens up Statin custom med list from |
| | anywhere within an update |
| Order lipid meds | Opens up lipid lowering custom med list |
| | from anywhere within an update |
| Order antibiotics | Opens up antibiotic custom med list from |
| | anywhere within an update |
| Order chest xray | Opens up Orders Module to field to order |
| | CXR from anywhere within an update |
| Order CBC | Opens up Orders Module to field to order |
| | CBC from anywhere within an update |
| Order MRI | Opens up Orders Module to field to order |
| | MRI from anywhere within an update |
| Go to (specify module or | Navigates to graphical encounter forms, or |
| encounter form) | various EMR modules (Problem List, |
| | Medication List, Allergy List, etc.) |
| Go to Asthma Plan Form | Navigates to (or loads and navigates to) the |
| | CCCQE ™ Asthma Plan Form |
| Go to Cardiovascular | Navigates to (or loads and navigates to) the |
| Reports Form | CCCQE ™ Cardiovascular Reports Form |
| Go to Preventive Care | Navigates to (or loads and navigates to) the |
| Form | CCCQE ™ Cardiovascular Reports Form |
| Go to Problems | Navigates to Problems Module to view, |
| | add, or edit |
| Go to Med List | Navigates to Medication Module to view, |
| | add, or edit |
| Go to Allergy List | Navigates to Allergy Module to view, add, |
| | or edit |
| Print (specify handout | Navigates to letter or handout list and |
| or letter) | automatically prints out specified letter or |
| | handout |
| Print Asthma Plan | Prints out Asthma Management Plan |
| Print Lipid Handout | Prints out Lipid Management Letter |
| Get (specify form for | Opens up external applications with forms |
| completion or diagram | or diagrams that can be completed, viewed, |
| to view or modify | or edited then saved into EMR |
| Get workers comp form | Opens up State specific Worker's |
| | Compensation Form for completion using |
| | CCCSpeak ™ |
| Get DOT form | Opens up Department of Transportation |
| | Form for completion using CCCSpeak ™ |
| Get knee | Opens up knee illustration for viewing or |
| | annotating |
| Get breast | Opens up breast illustration for viewing or |
| | annotating |

TABLE 2B
Voice Activated Workflow Functions - Normal Pap Report Review
and Send Letter

| | |
|---|---|
| 135. | Sign Pap Report |
| 136. | Open Patient Chart |
| 137. | Open Letter |
| | Module |
| 138. | Select Letter |
| | Template |
| 139. | Edit Letter |
| | Template (type or |
| | quick text) |
| 140. | Print Letter |
| 141. | Return to Chart or |
| | Desktop |
| 142. | Say “Normal Pap” (steps 1-4 above complete |
| | automatically) |
| 143. | Edit Letter with or without Edit Now |
| 144. | Say “Print Letter” to print and mail, “Send Letter” |
| | to open Secure e-mail application, encrypt and |
| | send, or “Fax Letter” to fax the letter |

Lipid Management - Review and Send Letter

| | |
|---|---|
| 001. | Sign Lipid Report |
| 002. | Open Chart |
| 003. | Append Document |
| 004. | Select Full Update |
| 005. | Load in NCEP/ATP |
| | III Lipid |
| | Management Form |
| 006. | Review Lipid |
| | Guidelines |
| 007. | Click on Print |
| | Letter |
| 008. | Select Letter |
| | Template |
| 009. | Edit Letter |
| | Template (type or |
| | quick text) |
| 010. | Print Letter |
| 011. | Return to Chart or |
| | Desktop |
| 012. | Say “Lipid Update” (Steps 1-5 above complete |
| | automatically) |
| 013. | Review Guidelines |
| 014. | Say “Send Lipid Letter” |
| 015. | Edit Letter using CCCSpeak with or without Edit |
| | Now |
| 016. | Say “Print Letter” to print and mail, “Send Letter” |
| | to open Secure e-mail application, encrypt and |
| | send, or “Fax Letter” to fax the letter |

TABLE 2C
View Lipid Flowsheet from within an update

| | |
|---|---|
| 001. | Close graphical |
| | encounter form |
| 002. | Select Flowsheet |
| | tab |
| 003. | Select appropriate |
| | flowsheet |
| 004. | Scroll to view last |
| | four values |
| 005. | Select “Return to |
| | Update” |
| 006. | Select prior |
| | graphical encounter |
| | form |
| 007. | Enter in results |
| | reviewed (typing) |
| 008. | From anywhere within an update simply say |
| | “View Lipid Flowsheet” and Windows pop-up |
| | screen appears with a display of the last four |
| | values of Cholesterol, LDL, HDL, and |
| | Triglycerides |
| 009. | View results then say “Yes” to insert results into |
| | current note or “No” not to add the results into the |
| | note |

TABLE 2D
Add Diagnosis (example UTI)

| | |
|---|---|
| 001. | Click on Add |
| | Diagnosis |
| | (Problems) field |
| 002. | Select Custom List |
| | or Reference List |
| 003. | Type in UTI or |
| | scroll to UTI |
| 004. | Click Enter |
| 005. | Click OK |
| 006. | Say “Add diagnosis UTI” and diagnosis of UTI |
| | added to problem list |

TABLE 2E
Add Medication (example: ordering a Statin-lipid lowering medication)

| | |
|---|---|
| 001. | Click on Add |
| | Medication field |
| 002. | Select Custom List |
| | or Reference List |
| 003. | Type in medication |
| | name or scroll to |
| | medication |
| 004. | Click Enter |
| 005. | Click OK |
| 006. | Say “Order Statin”; automatically brings to |
| | custom medication list for lipid lowering agents |
| 007. | Select Statin |
| 008. | Click OK |

In further illustrations of the considerations involved in aspects of implementing a VCND System 54 or VRE 56, it should be noted that a variety of core voice recognitions engines may be employed in the VRE 56, with suitable adaptations for the various versions or types of voice recognition engines. For example, if the core VRE 56 is Scansoft Dragon, some or all of Field of Use Character Library 72FU, Common Vocabulary Library 76CV and Command/Navigation Vocabulary 76CN may be implemented as dvc Dragon voice command files and coupled directly into the Dragon functions. In other instances, such as in a DS/ERS 10 and VCND System 54 based on the Microsoft Windows operating system, some or all of Field of Use Character Library 72FU, Common Vocabulary Library and Command/Navigation Vocabulary 76CN may be implemented as dll's, and so on.

It will therefore be understood that a specific implementation of a VCND System 54 according to the present invention will include functions, features and mechanisms adapting the VCND System 54 to the specific circumstances and context of the surrounding environment and mechanisms.

For example, a current implementation of a VCND System 54 of the present invention employs Scansoft Dragon, a popular voice recognition engine, as the core VRE 56. A problem with the use of Scansoft Dragon as the core VRE 56 in certain implementations, however, and in particular wherein the VCND System 54 is running remotely on a server and is accessed through a “Thin Client” process window, such as CITRIX or Microsoft Terminal Server. Essentially, the current version 7.3 of Scansoft Dragon cannot support or implement voice editing of dictated text within a VCND System 54 running remotely and accessed through a Thin Client process window.

For this reason and in these or similar circumstances, therefore, and as indicated in FIG. 7, a VCND System 54 of the present invention will include an Edit Now 74 mechanism, which enables voice editing of dictated text in a VCND System 54 running remotely within a Thin Client process window. In this regard, it will be appreciated that the specific implementation of an Edit Now 74 mechanism will depend, at least in part, on the specific form of the Thin Client process window and the characteristics and functions of the specific core VRE 56 used in the VCND System 54. An example of an embodiment of an Edit Now 74 mechanism for version 7.3 of the Scansoft Dragon VRE 56 is shown in Appendix B, however, to illustrate a typical embodiment of this mechanism and the mechanisms and functions implemented therein will be clear to those of ordinary skill in the relevant arts, as will the adaptation of this embodiment of an Edit Now 74 mechanism to other core VREs 56.

Lastly, and to further assist in understand the full range of mechanisms and embodiments that may be employed in an implementation of a VRE 56 or VCND System 54 of the present invention, Appendices B through E attached hereto disclose certain of the specific code routines and modules used in a present implementation of a VCND System 54. Attachments B and C are exemplary listings of routines for spoken or verbal commands and the entry of information in, for example, a diagnosis description. Attachment D is an exemplary listing for the expanded medical vocabulary described herein above, and Appendices E1 and E2 are listings of global command routines.

In conclusion, therefore, while the invention has been particularly shown and described with reference to preferred embodiments of the apparatus and methods thereof, it will be also understood by those of ordinary skill in the art that various changes, variations and modifications in form, details and implementation may be made therein without departing from the spirit and scope of the invention as defined by the appended claims. For example, Processes 32O and Medical Support Databases 30 may be implemented in a wide variety of ways and forms, and the fundamental decision/process support mechanisms and methods of the present invention may be applied to and implemented for a wide range of complex analysis/decision/procedural situations. Therefore, it is the object of the appended claims to cover all such variation and modifications of the invention as come within the true spirit and scope of the invention.

1. A voice navigation, command and data entry input system for a decision support and electronic record system, comprising:
a core voice recognition engine, including
a phoneme identification mechanism for identifying phonemes appearing in a voice input signal and generating corresponding phoneme identifiers, and
a word identification mechanism for identifying and providing words corresponding to the phoneme identifications as an output to the decision support and electronic record system,
an individual phoneme identification library associated with the phoneme identification mechanism for storing and providing phoneme identifications corresponding to phonemes characteristic of a voice input signal of a corresponding user, and
word libraries associated with the word identification mechanism for identifying and providing as an output words corresponding to the phoneme identifications wherein the words include at least one of a keystroke, a combination of keystrokes, a sequence of keystrokes, a word, a phrase, a character, a letter, a number, a symbol, a command and an instruction, including
a field of use library for storing and providing words specific to the field of use context of the decision support and electronic record system,
a command/navigation library for storing and providing keystroke sequences pertaining to navigation through and control of operations of the decision support and electronic record system, and
a common vocabulary library for storing and providing common words employed in operations of the decision support and electronic record system.

2. The voice navigation, command and data entry input system for a decision support and electronic record system of claim 1, further comprising:
a voice input device for generating the voice input signal, including
a plurality of voice input device keys for generating control/navigation input control signals for controlling control and navigation functions of the decision support and electronic record system.

3. The voice navigation, command and data entry input system for a decision support and electronic record system of claim 2, wherein:
at least certain of the control/navigation input control signals from the voice input device keys are provided as control inputs to the word identification mechanism and the command/navigation library includes and provides keystroke sequences corresponding to the control/navigation input control signals and pertaining to navigation through and control of operations of the decision support and electronic record system.

4. A method for voice navigation, command and data entry input for a decision support and electronic record system, comprising:
performing a core voice recognition process, including
identifying phonemes appearing in a voice input signal and generating corresponding phoneme identifiers, and
identifying and providing output words corresponding to the phoneme identifications as an output to the decision support and electronic record system, wherein
the phoneme identifications correspond to phonemes characteristic of a voice input signal of a corresponding user, and
the output words include at least one of a keystroke, a combination of keystrokes, a sequence of keystrokes, a word, a phrase, a character, a letter, a number, a symbol, a command and an instruction, and are selected from one of
words specific to the field of use context of the decision support and electronic record system,
keystroke sequences pertaining to navigation through and control of operations of the decision support and electronic record system, and
common words employed in operations of the decision support and electronic record system.

5. The method for voice navigation, command and data entry input for a decision support and electronic record system of claim 4, further comprising the steps of:
generating the voice input signal from a voice input device, and
generating control/navigation input control signals for controlling control and navigation functions of the decision support and electronic record system from a plurality of voice input device keys.

6. The method for voice navigation, command and data entry input for a decision support and electronic record system of claim 5, wherein:
the output word identification and providing step further includes
providing as output words keystroke sequences corresponding to the control/navigation input control signals and pertaining to navigation through and control of operations of the decision support and electronic record system.
